(19) United States
(12) Patent Application Publication
(10) Pub. No.: US 2023/0249100 A1
(43) Pub. Date: Aug. 10, 2023

(54) SUPERCRITICAL FLUID-ENHANCED SELECTIVE EXTRACTION OF RARE EARTH ELEMENTS

(71) Applicant: Washington University, St. Louis, MO (US)

(72) Inventors: Young-Shin JUN, St. Louis, MO (US); Yaguang ZHU, St. Louis, MO (US)

(21) Appl. No.: 18/003,769

(22) PCT Filed: Jul. 7, 2021
(86) PCT No.: PCT/US2021/040666

§ 371 Date: Dec. 29, 2022

Related U.S. Application Data
(60) Provisional application No. 63/049,698, filed on Jul. 9, 2020.

(51) Int. Cl. B01D 11/02; C01F 17/10; C22B 59/00; C22B 3/22; C22B 3/04; C22B 3/06

(52) U.S. Cl. CPC B01D 11/0203; B01D 11/028; B01D 11/0288; B01D 11/0292; C01F 17/10; C22B 3/04; C22B 3/22; C22B 3/065; C22B 59/00

(57) ABSTRACT

Abstract: Described herein is a process for obtaining rare earth elements from coal-based resources. Advantages of this process include low energy demands, application of environmentally-friendly solvents, and high purities of obtained rare earth elements.

### CROSS-REFERENCE TO RELATED APPLICATIONS

This application claims priority to U.S. Provisional Application Serial No. 63/049,698, filed on Jul. 9, 2020, the content of which is hereby incorporated by reference in its entirety.

### FIELD OF THE DISCLOSURE

Described herein is a process for obtaining rare earth elements from coal-based resources. Advantages of this process include low energy demands, application of environmentally-friendly solvents, and high purities of obtained rare earth elements.

### BACKGROUND OF THE DISCLOSURE

Rare earth elements (REEs) are a group of 17 chemical elements in the periodic table, specifically the 15 lanthanides plus scandium and yttrium. The wide application of REEs in computer memories, rechargeable batteries, cell phones, and fluorescent lightings manifests their indispensable roles in daily life. Moreover, they are also closely involved in a variety of high tech applications, such as clean energy generation and catalysis, and thus have been closely linked with the speed of technology development. However, due to their geopolitically constrained supply, environmentally unsustainable mining practices, and rapidly growing demand, both the United States (US) and the European Union have marked REEs as “critical materials.” Thus, alternative domestic sources would be most welcome.

Given limited geological resources and increasing consumption, recovering critical and valuable resources from postconsumer products or even waste is highly desirable. Beyond showing that supercritical fluid (SCF) can fundamentally enhance the selective extraction of REEs from coal fly ashes (CFA), this environmentally benign process can perform well in extracting REEs from other low grade REEs sources, including NiMH batteries, NdFeB magnets, and acid mine drainage.

Currently, mineral ores are the major sources of REE production. Other low grade REEs sources, including NiMH batteries, NdFeB magnets, and acid mine drainage, may also be used. However, unusable coals and coal ashes, which were previously considered as wastes and pollutants, can be promising resources for REEs. As one example, coal fly ash (CFA), has recently emerged as a promising REE source. In the United States, nearly 60% of the 45 Mt of CFA generated annually are simply disposed of, with minor portion being utilized in construction applications. The average total REE concentration in CFA has been characterized to be 200 - 1220 ppm, and the potential annual value of the REEs that can be extracted from CFAs in the US is estimated to be $4.3 billion.

Different methods have been applied to extract REEs from CFA. All of them require a high temperature alkaline roasting process followed by an acid leaching process to obtain REE-containing leachate. Then, an organic solvent extraction or liquid membrane process has been executed to extract the REEs from the leachate into collection solutions. However, many problems remain. First, the high energy and chemical demands have proved to be burdens in commercial extraction of REEs from mineral ores, and these burdens will be severer for low grade REEs sources like CFA. Second, the applied organic solvent in those processes is toxic and environmentally unfriendly. Third, and most important, due to the extremely low concentrations of REEs (< 0.2 %) compared to the more than 90% of major impurities (Ca, Fe, Al, and Mg) in CFA, the REEs purity in the final products is only 0.5 - 0.7%.

To overcome these drawbacks, an REEs extraction process that is environmentally-benign and highly selective for REEs over impurities is necessary. Supercritical fluid (SCF) extraction has emerged as a promising option for this purpose because it has little environmental impact, is non-flammable, facilitates mass transfer, and has high selectivity. Due to these physicochemical properties, SCF has been widely used in extraction and drying processes in the food and petroleum industries, chemical synthesis, analysis, and materials processing. Studies found that after complexing with extractant, such as tributyl phosphate-nitric acid complex (TBP-HNO₃), REEs can become soluble in supercritical CO₂ (_{SC}CO₂). Researchers have successful extended this application, originally designed to extract REEs from pure REEs oxides, to other REE-rich sources, such as bastnaesite, NiMH batteries, and NdFeB magnets. Nevertheless, using SCF to extract REEs from a complicated matrix like CFA and whether impurities will also complex with TBP-HNO₃ to interfere the REEs selectivity has never been explored.

Described herein is an extraction process to directly and selectively extract REEs from solid coal-based resources with the assistance of supercritical fluid. These supercritical fluids include not only _{SC}CO₂ but also other supercritical fluids such as air and nitrogen. High extraction efficiencies, between 66 - 79% for all REEs, were achieved. It was surprisingly discovered that _{SC}CO₂ decreases the concentrations of impurities in the final products, especially Ca, Mg, and Al. Further, the sources of SCF were expanded beyond CO₂ to more easily accessible gases such as nitrogen and air. For the first time, these gases were demonstrated to exhibit excellent performance in extracting REEs and separating impurities. Through studying the fate of REEs and impurities in the present process, it was found that SCF interacts with the extractant (TBP-HNO₃) to change its reactivity and achieve selective extraction of REEs, overturning the traditional view that SCF are inert during the extraction process.

There are several advantages to the present extraction process, including less energy and chemical demand, an environmentally friendly solvent, and much higher REEs purity in the final product. The present disclosure presents an outstanding process for extracting REE from coal-based resources, offers new choices of SCF, and provides new insights into the selectivity in SCF extraction.

### BRIEF DESCRIPTION OF THE DISCLOSURE

In one embodiment, the present disclosure is directed to a process for obtaining a rare earth element from a coal-based resource, the process comprising (i) forming a mixture comprising an extractant complex and a coal-based resource comprising a rare earth element, (ii) extracting the rare earth element from the mixture in the presence of a supercritical fluid, and (iii) recovering the rare earth element in at least one stripping stage.

In one embodiment, the present disclosure is directed to a process for obtaining at least one rare earth element from a coal-based resource, the process comprising (i) forming a mixture comprising an extractant complex and a coal-based resource comprising at least one rare earth element, (ii) extracting the at least one rare earth element from the mixture in the presence of a supercritical fluid, and (iii) recovering the at least one rare earth element in at least one stripping stage.

### BRIEF DESCRIPTION OF THE DRAWINGS

FIG. 1A is an exemplary embodiment of a process of generating TBP-HNO₃ in a process for supercritical fluid extraction of rare earth elements from coal-based resources in accordance with the present disclosure.

FIG. 1B is an exemplary embodiment of a process of extracting REEs in supercritical fluid in a process for supercritical fluid extraction of rare earth elements from coal-based resources in accordance with the present disclosure.

FIG. 1C is an exemplary embodiment of a multistage stripping process in a process for supercritical fluid extraction of rare earth elements from coal-based resources in accordance with the present disclosure.

FIG. 2A is an exemplary embodiment of a CFA in accordance with the present disclosure. The scale bar is 1 cm.

FIG. 2B is an exemplary embodiment of an elemental characterization of a CFA in accordance with the present disclosure. Numbers in the top plot indicate the concentrations of total REEs. The numbers in the bottom plot indicate the concentrations of representative REEs. The figure is labeled with the total REE content.

FIG. 2C is an exemplary embodiment of an SEM image of a representative morphology of a CFA in accordance with the present disclosure. The scale bar is 5 µm.

FIG. 2D is an exemplary embodiment of an SEM image of a representative morphology of a CFA in accordance with the present disclosure. The scale bar is 20 µm.

FIG. 2E is an exemplary embodiment of an SEM image of a representative morphology of a CFA in accordance with the present disclosure. The scale bar is 10 µm.

FIG. 3A is an exemplary embodiment of the concentrations of representative REEs (Y, La, Ce, Nd, Gd) and major impurities (Ca, Fe, Al, and Mg) in stripped solutions from a multistage stripping process after 50° C. and 150 bar _{SC}CO₂ extraction in accordance with the present disclosure.

FIG. 3B is an exemplary embodiment of the concentrations of representative REEs (Y, La, Ce, Nd, Gd) and major impurities (Ca, Fe, Al, and Mg) in stripped solutions from a multistage stripping process after 50° C. without any gases extraction (heat only condition) in accordance with the present disclosure.

FIG. 3C is an exemplary embodiment of the concentrations of representative REEs (Y, La, Ce, Nd, Gd) and major impurities (Ca, Fe, Al, and Mg) in stripped solutions from a multistage stripping process after 50° C. and 150 bar scN₂ extraction in accordance with the present disclosure.

FIG. 3D is an exemplary embodiment of the concentrations of representative REEs (Y, La, Ce, Nd, Gd) and major impurities (Ca, Fe, Al, and Mg) in stripped solutions from a multistage stripping process after 50° C. and 150 bar scAir extraction in accordance with the present disclosure.

FIG. 4A is an exemplary embodiment of the concentrations of representative REEs (Y, La, Ce, Nd, Gd) and major impurities (Ca, Fe, Al, and Mg) in stripped solutions from a multistage stripping process after 50° C. and 150 bar _{SC}CO₂ extraction with fresh TBP-HNO₃ in accordance with the present disclosure.

FIG. 4B is an exemplary embodiment of the concentrations of representative REEs (Y, La, Ce, Nd, Gd) and major impurities (Ca, Fe, Al, and Mg) in stripped solutions from a multistage stripping process after 50° C. and 150 bar _{SC}CO₂ extraction with regenerated TBP-HNO₃ in accordance with the present disclosure.

FIG. 5A is an exemplary embodiment of the fates of major impurities (Ca, Fe, Mg, and Al) in the extraction process in accordance with the present disclosure.

FIG. 5B is an exemplary embodiment of the fate of REEs in the extraction process in accordance with the present disclosure. Unextracted portions are the elements remaining in the solid residues after extraction. Uncollected portions are elements that leached from CFA but were not collected in stripping solutions.

FIG. 5C is an exemplary embodiment of the concentration of TBP-complexed impurities under the heating-only, _{SC}CO₂, _{SC}N₂, and scAir conditions in the extraction process in accordance with the present disclosure.

FIG. 6 is an exemplary embodiment of a proposed mechanism for the SCF-enhanced selectivity for REEs over major impurities (Ca, Mg, Al). First, REEs and impurities leach from CFA to form metal nitrates. Then, the presence of SCF affects the reactivity of TBP. In the heating-only condition (left), all metal nitrates preferentially form complexes with TBP. But under the SCF condition (right), only REEs and Fe still preferentially form complexation with TBP. The number of symbols for metal-TBP complexes shown in the figure represents the extents of preferentially complex formation, not their quantities.

FIG. 7 is an exemplary embodiment of the REE patterns of a CFA sample normalized by upper continental crust (UCC) in accordance with the present disclosure.

FIG. 8A is an exemplary embodiment of the fates of SEM images and EDX elemental mappings of a CFA particle in accordance with the present disclosure.

FIG. 8B is an exemplary embodiment of the fates of SEM images and EDX elemental mappings of a CFA particle in accordance with the present disclosure.

FIG. 8C is an exemplary embodiment of the fates of SEM images and EDX elemental mappings of a CFA particle in accordance with the present disclosure.

FIG. 9A is an exemplary embodiment of a photograph of the interface between reacted TBP-HNO₃ and 1% nitric acid under _{SC}CO₂ conditions in accordance with the present disclosure.

FIG. 9B is an exemplary embodiment of a photograph of the interface between reacted TBP-HNO₃ and 1% nitric acid under heating only conditions in accordance with the present disclosure.

FIG. 9C is an exemplary embodiment of a photograph of the interface between reacted TBP-HNO₃ and 1% nitric acid under scN₂ conditions in accordance with the present disclosure.

FIG. 9D is an exemplary embodiment of a photograph of the interface between reacted TBP-HNO₃ and 1% HNO₃ under scAir conditions in accordance with the present disclosure.

FIG. 10 is an exemplary embodiment of the extraction efficiency of representative REEs from BA and CFA and neodymium’s concentration in stripping solutions and stripping efficiency at different TBP-HNO₃: 1% HNO₃ volume ratios in accordance with the present disclosure.

FIG. 11A is an exemplary embodiment of the extraction efficiency of REEs from CFA under _{SC}CO₂ conditions in accordance with the present disclosure.

FIG. 11B is an exemplary embodiment of the extraction efficiency of REEs from CFA under scN₂ conditions in accordance with the present disclosure.

FIG. 11C is an exemplary embodiment of the extraction efficiency of REEs from CFA under scAir conditions in accordance with the present disclosure.

FIG. 12A is an exemplary embodiment of a process of generating TBP-HNO₃ in a process for supercritical fluid extraction of rare earth elements from coal-based resources in accordance with the present disclosure.

FIG. 12B is an exemplary embodiment of a process of extracting REEs in supercritical fluid in a process for supercritical fluid extraction of rare earth elements from coal-based resources in accordance with the present disclosure.

FIG. 12C is an exemplary embodiment of a multistage stripping process in a process for supercritical fluid extraction of rare earth elements from coal-based resources in accordance with the present disclosure.

FIG. 12D is an exemplary embodiment of an extractant regeneration process in a process for supercritical fluid extraction of rare earth elements from coal-based resources in accordance with the present disclosure.

FIG. 13 is an exemplary embodiment of CBRs in accordance with the present disclosure. The CBRs include coal, bottom ash (BA), coal fly ash - Missouri (CFA-M), coal fly ash - Kentucky (CFA-K), and coal fly ash - Texas (CFA-T). The first image in each column is a photograph of the CBR particles, and the scale bars are 1 cm. The other images in each column are SEM images showing CBRs′ representative morphologies, and the scale bars are 5 µm.

FIG. 14A is an exemplary embodiment of the concentrations of total REEs and major impurities (Ca, Fe, Al, and Mg) in stripping solutions from different stripping stages for a CFA-M sample in accordance with the present disclosure.

FIG. 14B is an exemplary embodiment of the concentrations of total REEs and major impurities (Ca, Fe, Al, and Mg) in stripping solutions from different stripping stages for a CFA-T sample in accordance with the present disclosure.

FIG. 14C is an exemplary embodiment of the concentrations of total REEs and major impurities (Ca, Fe, Al, and Mg) in stripping solutions from different stripping stages for a CFA-K sample in accordance with the present disclosure.

FIG. 15A is an exemplary embodiment of the regeneration of the extractant TBP-HNO₃ for minimizing organic chemical usage for TBP-complexed metal concentrations before and after the multistage stripping process in accordance with the present disclosure.

FIG. 15B is an exemplary embodiment of the performance of regenerated TBP-HNO₃ in selectively extracting REEs from CFA-M in accordance with the present disclosure.

FIG. 16A is an exemplary embodiment of concentrations of representative REEs and major impurities (Ca, Fe, Al, and Mg) in stripping solutions from different stripping stages using a 3:1 solid-to-liquid ratio in accordance with the present disclosure.

FIG. 16B is an exemplary embodiment of complexed metal concentrations in extraction experiments with solid-to-liquid ratios of 2 mg CFA - 20 ml TBP-HNO₃, and 6 mg CFA - 20 ml TBP-HNO₃ in accordance with the present disclosure.

FIG. 17A is an exemplary embodiment of the elemental characterization of coal, BA, and CFA-M for, in the upper panel, the total concentrations of major impurities (Fe, Ca, Na, Al), and REEs and, in the lower panel, the concentrations of representative REEs, in accordance with the present disclosure. The figure is labeled with the total REE content.

FIG. 17B is an exemplary embodiment of the elemental characterization of coal, BA, and CFA-M for, in the upper panel, the concentrations of acid extractable impurities (Fe, Al, and Na), and REEs and, in the lower panel, the concentrations of representative acid extractable REEs, in accordance with the present disclosure. The figure is labeled with the total REE content.

FIG. 18 is an exemplary embodiment of the extraction efficiency of representative REEs from BA and CFA-M in accordance with the present disclosure.

FIG. 19A is an exemplary embodiment of the fates of SEM images and EDX elemental mappings of a CFA particle in accordance with the present disclosure.

FIG. 19B is an exemplary embodiment of the fates of SEM images and EDX elemental mappings of a CFA particle in accordance with the present disclosure.

FIG. 19C is an exemplary embodiment of the fates of SEM images and EDX elemental mappings of a CFA particle in accordance with the present disclosure.

FIG. 20A is an exemplary embodiment of the impurities and REEs concentration in all ten-stage stripping process when using 2 g CFA-M and 20 ml TBP-HNO₃ as solid-to-liquid ratio in accordance with the present disclosure.

FIG. 20B is an exemplary embodiment of the impurities and REEs concentration in all ten-stage stripping process when using 6 g CFA-M and 20 ml TBP-HNO₃ as solid-to-liquid ratio in accordance with the present disclosure.

### DETAILED DESCRIPTION OF THE DISCLOSURE

Described herein is a process that utilizes supercritical (sc) fluids (e.g., _{SC}CO₂, _{SC}N₂, and scAir) to selectively extract and obtain rare earth elements (REEs) from coal-based resources.

As used herein, rare earth elements include scandium (Sc), yttrium (Y), and the lanthanides including lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu).

In some embodiments, the REEs extraction processes in accordance with the present disclosure have four steps. The first step is to generate an extractant complex, which is the extractant for the process. The extractant strongly complexes with REEs and extracts them from solid matrices.

In some embodiments, the extractant is a tri-n-butyl phosphate (TBP)-HNO₃ complex. In these embodiments, the extractant complex is prepared by vigorously mixing two equal volumes of TBP and concentrated nitric acid (HNO₃), followed by gravity separation. The organic layer consists of the extractant complex. One feature of this process is that the solid residue is the only waste generated: i.e., there is no liquid waste. This is a clear difference from other extraction processes.

TBP has strong complexation with rare earth elements. In addition, previous studies have proved that TBP has strong complexation with actinides, especially uranium and thorium. Therefore, it is expected that TBP can also be applied to recover actinides from nuclear products.

The second step is conducting the REEs extraction from coal-based resources (CBRs) under supercritical fluid. CBRs are mixed with the extractant complex, and then a pre-heated and pressurized supercritical fluid, such as _{SC}CO₂, _{SC}N₂, or scAir, is injected into the reaction system. One unique feature here is that CO₂, nitrogen, air, or their mixtures are all individually applicable in this process, as long as the gas is in the supercritical state (i.e., temperature and pressure conditions are higher than the critical temperature and pressure for the gas). The critical temperatures and critical pressures for CO₂, N₂, and air are 31.0° C. and 72.8 atm, -147.0° C. and 33.6 atm, and -140.5° C. and 37.4 atm, respectively. After 2 hours of extraction, the reactor is cooled to room temperature and then depressurized. In some embodiments, reacted TBP-HNO₃, which contains REEs and impurities, is obtained by filtering out the remaining solid residues.

The third step is conducting a multistage stripping process to selectively collect the REEs and separate them from the impurities. In some embodiments, a majority of impurities are collected in a former portion of stripping stages. In some embodiments, the REEs are collected in a latter portion of stripping stages. In some embodiments, different REEs are collected in different stripping stages. One unique feature here is that particular volume ratios, such as a 10:1 volume ratio, used helps both to concentrate the REEs and at the same time to separate them from the impurities.

In some embodiments, the multistage stripping process uses diluted nitric acid. In these embodiments, diluted nitric acid is added to reacted TBP-HNO₃ in 10:1 as volume ratio of TBP-HNO₃ and 1% nitric acid. Then, after vigorous mixing, the REEs and impurities dissociate from the TBP and dissolve into the diluted nitric acid. The diluted nitric acid containing REEs and impurities, collected by gravity separation, is called a stripped solution. The remaining reacted TBP-HNO₃ is mixed with fresh diluted nitric acid to conduct a new stripping stage. In total, ten stage stripping stages are needed to recover all the REEs from the reacted TBP-HNO₃. The majority of the impurities are collected in the stripped solution collected from the first through third stages of the stripping process. In contrast, the REEs are collected in the stripped solution collected from the fourth through tenth stages of the stripping process.

The fourth step is regenerating new extractant complex from the reacted extractant complex after the multistage stripping process. After the multistage stripping process, the majority of the originally complexed REEs and impurities have been stripped out. Hence, in some embodiments, the remaining extractant complex is regenerated into new extractant complex and applied again to extract REEs from new CBR. One unique feature here is that by regenerating the extractant, “zero” organic waste disposal is approached.

In some embodiments, new TBP-HNO₃ is regenerated from reacted TBP-HNO₃ after a ten-stage stripping process. In these embodiments, the regeneration procedure is to mix stripped TBP-HNO₃ with new acid, such as 70% concentrated nitric acid. Then, the regenerated TBP-HNO₃ is used for reacting with fresh CBRs to extract REEs.

In some embodiments, new TBP-HNO₃ is regenerated from a process step of regenerating the extractant comprising (i) mixing reacted TBP-HNO₃ with fresh 70% nitric acid; (ii) performing a gravity separation of a mixture of an acid and the extractant; and (iii) recovering a regenerated extractant from a top layer of the gravity separation.

In some embodiments, the present disclosure is directed to a process for obtaining a rare earth element from a coal-based resource, the process comprising (i) forming a mixture comprising an extractant complex and a coal-based resource comprising a rare earth element, (ii) extracting the rare earth element from the mixture in the presence of a supercritical fluid, and (iii) recovering the rare earth element in at least one stripping stage.

In some embodiments, the present disclosure is directed to a process for obtaining at least one rare earth element from a coal-based resource, the process comprising (i) forming a mixture comprising an extractant complex and a coal-based resource comprising at least one rare earth element, (ii) extracting the at least one rare earth element from the mixture in the presence of a supercritical fluid, and (iii) recovering the at least one rare earth element in at least one stripping stage.

In some embodiments, the coal-based resource is selected from the group consisting of coal, coal ash, acid mine drainage, and combinations thereof.

In some embodiments, the extractant complex is formed according to a process comprising mixing an extractant and an acid.

In some embodiments, the extractant complex is formed according to a process comprising mixing an extractant and an acid, wherein the extractant is selected from the group consisting of tributyl phosphate (TBP), thenoyltrifluoroacetone (TTA), trialkylphosphine oxide (TRPO), and combinations thereof.

In some embodiments, the extractant complex is formed according to a process comprising mixing an extractant and an acid, wherein the acid is selected from the group consisting of nitric acid, hydrochloric acid, sulfuric acid, and combinations thereof.

In some embodiments, the extractant complex is selected from the group consisting of TBP-HNO₃, TTA-HNO₃, TRPO-HNO₃, β-diketone, and combinations thereof.

In some embodiments, the extractant complex is a regenerated extractant complex. In some embodiments, the extractant complex is a regenerated extractant complex that has been regenerated more than one time.

In some embodiments, the mixture comprises a solid-to-liquid ratio in a range of from about 1 mg coal-based resource : 20 ml extractant complex to about 10 mg coal-based resource : 20 ml extractant complex. In some embodiments, the mixture comprises a solid-to-liquid ratio in a range of from about 2 mg coal-based resource : 20 ml extractant complex to about 6 mg coal-based resource : 20 ml extractant complex. In some embodiments, the mixture comprises a solid-to-liquid ratio of about 6 mg coal-based resource : 20 ml extractant complex.

In some embodiments, the supercritical fluid is selected from the group consisting of supercritical CO₂, supercritical N₂, supercritical air, ethane, propane, ethylene, propylene, nitrous oxide, and combinations thereof.

In some embodiments, the supercritical fluid is selected from the group consisting of supercritical CO₂, supercritical N₂, supercritical air, and combinations thereof.

In some embodiments, the supercritical fluid is supercritical CO₂.

In some embodiments, the process step of recovering the rare earth element in at least one stripping stage comprises recovering the rare earth element in one stripping stage. In some embodiments, the process step of recovering the rare earth element in at least one stripping stage comprises recovering the rare earth element in at least two stripping stages. In some embodiments, the process step of recovering the rare earth element in at least one stripping stage comprises recovering the rare earth element in at least three stripping stages. In some embodiments, the process step of recovering the rare earth element in at least one stripping stage comprises recovering the rare earth element in at least four stripping stages. In some embodiments, the process step of recovering the rare earth element in at least one stripping stage comprises recovering the rare earth element in at least five stripping stages. In some embodiments, the process step of recovering the rare earth element in at least one stripping stage comprises recovering the rare earth element in at least six stripping stages. In some embodiments, the process step of recovering the rare earth element in at least one stripping stage comprises recovering the rare earth element in at least seven stripping stages. In some embodiments, the process step of recovering the rare earth element in at least one stripping stage comprises recovering the rare earth element in at least eight stripping stages. In some embodiments, the process step of recovering the rare earth element in at least one stripping stage comprises recovering the rare earth element in at least nine stripping stages. In some embodiments, the process step of recovering the rare earth element in at least one stripping stage comprises recovering the rare earth element in at least ten stripping stages. In some embodiments, the process step of recovering the rare earth element in at least one stripping stage comprises recovering the rare earth element in more than ten stripping stages.

In some embodiments, the process step of recovering the rare earth element in at least one stripping stage comprises recovering the rare earth element in six stripping stages. In some embodiments, the majority of REEs can be collected from the first through sixth stripping stages.

In some embodiments, the rare earth element obtained from the coal-based resource is essentially free of an impurity. In some embodiments, the rare earth element obtained from the coal-based resource consists of one impurity. In some embodiments, the rare earth element obtained from the coal-based resource consists of two impurities. In some embodiments, the rare earth element obtained from the coal-based resource consists of three impurities. In some embodiments, the rare earth element obtained from the coal-based resource consists of four impurities. In some embodiments, the rare earth element obtained from the coal-based resource consists of five impurities.

In some embodiments, the concentration of the impurities is less than about 97% for the fourth, fifth, and sixth stripping solutions.

As used herein, impurities include major impurities selected from calcium (Ca), iron (Fe), aluminum (Al), magnesium (Mg), and silicon (Si), as well as minor impurities selected from barium (Ba), cadmium (Cd), cobalt (Co), chromium (Cr), copper (Cu), manganese (Mn), molybdenum (Mo), nickel (Ni), lead (Pb), thallium (Tl), uranium (U), vanadium (V), and zinc (Zn).

In some embodiments, the impurity is selected from the group consisting of calcium, iron, aluminum, magnesium, silicon, and combinations thereof.

In many embodiments, the coal-based resource comprises a rare earth element. In many embodiments, the coal-based resource comprises at least one rare earth element. In many embodiments, the coal-based resource comprises rare earth elements. In some embodiments, the coal-based resource comprises at least one rare earth element. In some embodiments, the coal-based resource comprises at least two rare earth elements. In some embodiments, the coal-based resource comprises at least three rare earth elements. In some embodiments, the coal-based resource comprises at least four rare earth elements. In some embodiments, the coal-based resource comprises at least five rare earth elements. In some embodiments, the coal-based resource comprises at least ten rare earth elements. In some embodiments, the coal-based resource comprises more than ten rare earth elements. In some embodiments, the coal-based resource comprises seventeen rare earth elements.

In some embodiments, the coal-based resource comprises seventeen rare earth elements.

In some embodiments, the process step of recovering the rare earth element in at least one stripping stage comprises selectively recovering at least one rare earth element. In some embodiments, the process step of recovering the rare earth element in at least one stripping stage comprises selectively recovering at least two rare earth elements. In some embodiments, the process step of recovering the rare earth element in at least one stripping stage comprises selectively recovering at least three rare earth elements. In some embodiments, the process step of recovering the rare earth element in at least one stripping stage comprises selectively recovering at least four rare earth elements. In some embodiments, the process step of recovering the rare earth element in at least one stripping stage comprises selectively recovering at least five rare earth elements. In some embodiments, the process step of recovering the rare earth element in at least one stripping stage comprises selectively recovering at least ten rare earth elements. In some embodiments, the process step of recovering the rare earth element in at least one stripping stage comprises selectively recovering more than ten rare earth elements. In some embodiments, the process step of recovering the rare earth element in at least one stripping stage comprises selectively recovering seventeen rare earth elements.

In some embodiments, the process step of recovering the rare earth element in at least one stripping stage comprises recovering the rare earth element at a concentration of at least about 1 mg/L. In some embodiments, the process step of recovering the rare earth element in at least one stripping stage comprises recovering the rare earth element at a concentration in the range of from about 1 mg/L to about 100 mg/L. In some embodiments, the process step of recovering the rare earth element in at least one stripping stage comprises recovering the rare earth element at a concentration in the range of from about 1 mg/L to about 50 mg/L. In some embodiments, the process step of recovering the rare earth element in at least one stripping stage comprises recovering the rare earth element at a concentration in the range of from about 1 mg/L to about 25 mg/L. In some embodiments, the process step of recovering the rare earth element in at least one stripping stage comprises recovering the rare earth element at a concentration in the range of from about 10 mg/L to about 25 mg/L.

In some embodiments, the process step of recovering the rare earth element in at least one stripping stage comprises recovering the rare earth element at a concentration in the range of from about 11.4 mg/L to about 21.4 mg/L.

In some embodiments, the process step of recovering the rare earth element in at least one stripping stage comprises selectively recovering at least one rare earth element in at least one stripping stage. In some embodiments, the process step of recovering the rare earth element in at least one stripping stage comprises selectively recovering at least one rare earth element in at least two stripping stages. In some embodiments, the process step of recovering the rare earth element in at least one stripping stage comprises selectively recovering at least one rare earth element in at least three stripping stages. In some embodiments, the process step of recovering the rare earth element in at least one stripping stage comprises selectively recovering at least one rare earth element in at least four stripping stages. In some embodiments, the process step of recovering the rare earth element in at least one stripping stage comprises selectively recovering at least one rare earth element in at least five stripping stages. In some embodiments, the process step of recovering the rare earth element in at least one stripping stage comprises selectively recovering at least one rare earth element in at least six stripping stages. In some embodiments, the process step of recovering the rare earth element in at least one stripping stage comprises selectively recovering at least one rare earth element in at least seven stripping stages. In some embodiments, the process step of recovering the rare earth element in at least one stripping stage comprises selectively recovering at least one rare earth element in at least eight stripping stages. In some embodiments, the process step of recovering the rare earth element in at least one stripping stage comprises selectively recovering at least one rare earth element in at least nine stripping stages. In some embodiments, the process step of recovering the rare earth element in at least one stripping stage comprises selectively recovering at least one rare earth element in at least ten stripping stages. In some embodiments, the process step of recovering the rare earth element in at least one stripping stage comprises selectively recovering at least one rare earth element in more than ten stripping stages.

In some embodiments, the process step of recovering the rare earth element in at least one stripping stage comprises selectively recovering at least one rare earth element in at least six stripping stages.

In some embodiments, selectively recovering the rare earth element means that the recovered rare earth element consists of one rare earth element. In some embodiments, selectively recovering the rare earth element means that the recovered rare earth element consists of two rare earth elements. In some embodiments, selectively recovering the rare earth element means that the recovered rare earth element consists of three rare earth elements. In some embodiments, selectively recovering the rare earth element means that the recovered rare earth element consists of four rare earth elements. In some embodiments, selectively recovering the rare earth element means that the recovered rare earth element consists of five rare earth elements. In some embodiments, selectively recovering the rare earth element means that the recovered rare earth element consists of six rare earth elements. In some embodiments, selectively recovering the rare earth element means that the recovered rare earth element consists of seven rare earth elements. In some embodiments, selectively recovering the rare earth element means that the recovered rare earth element consists of eight rare earth elements. In some embodiments, selectively recovering the rare earth element means that the recovered rare earth element consists of nine rare earth elements. In some embodiments, selectively recovering the rare earth element means that the recovered rare earth element consists of ten rare earth elements. In some embodiments, selectively recovering the rare earth element means that the recovered rare earth element consists of eleven rare earth elements. In some embodiments, selectively recovering the rare earth element means that the recovered rare earth element consists of twelve rare earth elements. In some embodiments, selectively recovering the rare earth element means that the recovered rare earth element consists of thirteen rare earth elements. In some embodiments, selectively recovering the rare earth element means that the recovered rare earth element consists of fourteen rare earth elements. In some embodiments, selectively recovering the rare earth element means that the recovered rare earth element consists of fifteen rare earth elements. In some embodiments, selectively recovering the rare earth element means that the recovered rare earth element consists of sixteen rare earth elements. In some embodiments, selectively recovering the rare earth element means that the recovered rare earth element consists of seventeen rare earth elements.

In some embodiments, selectively recovering the rare earth element means that the recovered rare earth element consists of seventeen rare earth elements.

In some embodiments, the process further comprises regenerating the extractant.

In some embodiments, the process step of regenerating the extractant comprises adding an acid to the extractant.

In some embodiments, the REEs extracted and recovered using the processes of the present disclosure have a purity of from about 1% to about 16%, from about 1% to about 10%, from about 3% to about 9%, from about 4% to about 7%, or from about 5% to about 6.5%. In some embodiments, the extracted and recovered REEs have a purity of about 1%, about 2%, about 3%, about 4%, about 5%, about 6%, about 7%, about 8%, about 9%, about 10%, about 11%, about 12%, about 13%, about 14%, about 15%, or about 16%. In some embodiments, the extracted and recovered REEs have a purity of from about 2.5% to about 5.0%, from about 3.5% to about 9.0%, or from about 1.5% to about 7.5%. The as-produced higher purity of the REEs decreases the cost and process complexity that is otherwise needed to obtain a high purity REEs product. The REEs purity is calculated using Equation 2, disclosed in the Examples.

### EXAMPLES

Without further elaboration, it is believed that one skilled in the art using the preceding description can utilize the present invention to its fullest extent. The following Examples are, therefore, to be construed as merely illustrative, and not limiting of the disclosure in any way whatsoever. The starting material for the following Examples may not have necessarily been prepared by a particular preparative run whose procedure is described in other Examples. It also is understood that any numerical range recited herein includes all values from the lower value to the upper value. For example, if a range is stated as 10-50, it is intended that values such as 12-30, 20-40, or 30-50, etc., are expressly enumerated in this specification. These are only examples of what is specifically intended, and all possible combinations of numerical values between and including the lowest value and the highest value enumerated are to be considered to be expressly stated in this application.

### Example 1 Extraction Process

The present processes utilize supercritical (sc) fluids (_{SC}CO₂, _{SC}N₂, and scAir) to selectively extract rare earth elements (REEs) from coal fly ash (CFA). The coal fly ash in this disclosure came from a power plant in Missouri, which originated in the Powder River Basin (PRB). Deionized water (18.2 MQ-cm) obtained from a Barnstead Ultrapure Water System (D11931, Thermo Scientific) and American Chemical Society grade chemicals were used.

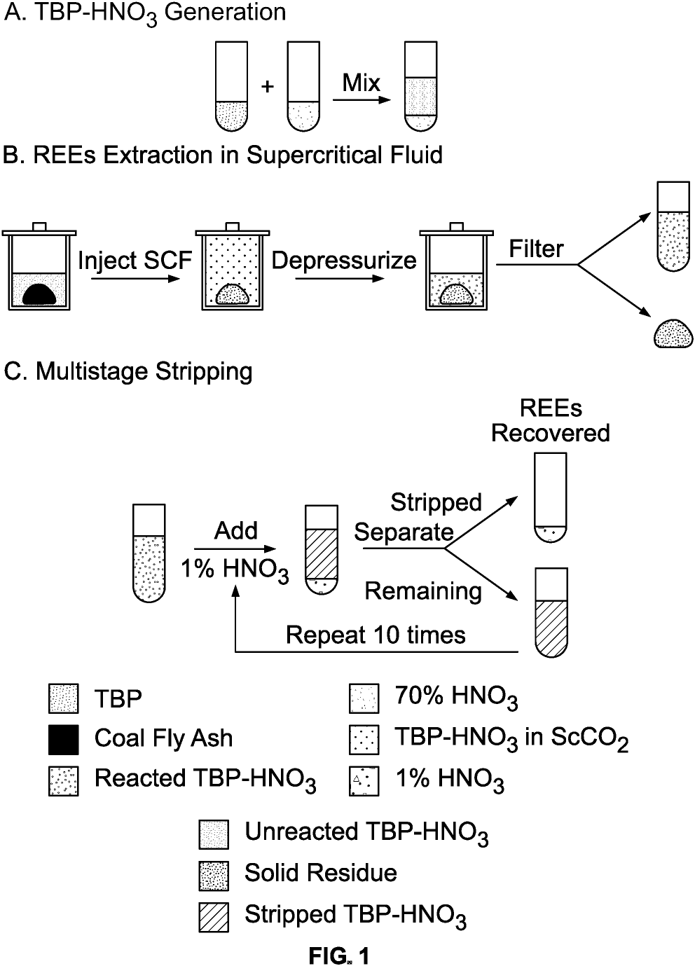

This REE extraction process has three steps, as shown in FIG. 1. The first step is to generate a tributyl phosphate (TBP-HNO₃) complex, which was the extractant for the process. The extractant was prepared by vigorously mixing two equal volumes of TBP and concentrated nitric acid (70% HNO₃), followed by gravity separation. The upper organic layer was the TBP-HNO₃ extractant. The extractant strongly complexes with REEs and extracts them from the CFA.

The second step was conducting the REEs extraction from CFA under supercritical fluid. The CO₂, N₂, and air used were purchased from Airgas. 2 g of CFA, along with 20 mL TBP-HNO₃, was loaded into a reactor (250 mL, Parr Instrument Co., IL). SCF was pressurized by a syringe pump (Teledyne Isco Inc., Lincoln, NE) and maintained at 150 bar. The temperature of the reactor was controlled at 50° C. After 2 hours of extraction, the reactor was cooled to room temperature and depressurized. Reacted TBP-HNO₃, which contained REEs and impurities, was obtained by filtering out the remaining solid residues. The solid residues were rinsed with ethanol and DI water to remove any remaining solution from the extraction process and then prepared for further characterization. Triplicate experiments were conducted for each condition.

The third step was conducting the multistage stripping process to selectively collect the REEs and separate them from the impurities using 1% nitric acid. Specifically, 1% nitric acid was added into reacted TBP-HNO₃ with 10: 1 volume/ volume ratio of TBP-HNO₃: 1% nitric acid. This volume ratio was experimentally determined to be the best for concentrating REEs. Then, after vigorous mixing, the REEs and impurities dissociated from the TBP and dissolved into the diluted nitric acid. The diluted nitric acid containing REEs and impurities, collected by gravity separation, was called stripped solution. The remaining reacted TBP-HNO₃ was mixed with fresh 1% nitric acid to conduct a new stripping stage. In total, a ten-stage stripping process was needed to recover essentially all the REEs from the reacted TBP-HNO₃.

### Characterization of Solid Samples

The sizes, morphologies, and elemental distributions of CFA were characterized by SEM-EDX (Thermofisher Quattro S Environmental Scanning Electron Microscope). The CFA sample was digested by two methods to respectively obtain the total elemental composition and acid-extractable REEs element composition. In addition, the solid residues obtained after the extraction were digested to obtain the total elemental composition to calculate the extraction efficiency. Extraction efficiency was calculated as Equation 1:

$$E x t r a c t i o n e f f i c i e n c y = \frac{w t {\%}_{u} \times {m}_{u} - w t {\%}_{r} \times {m}_{r}}{w t {\%}_{u} \times {m}_{u}} \times 100 \%$$

where wt%ᵤ is the mass percentages of the elements in the unreacted CFA, mᵤ is the mass of unreacted CFA, wt%ᵣ is the mass percentage of the elements in the reacted CFA, and mᵣ is the mass of the reacted CFA.

The digestion in this study was performed in a microwave digester. To quantify the total elemental composition, coal fly ash samples (34 ± 1 mg) were digested for 8 h at 90 - 100° C. in a 1:1 mixture of 2 mL concentrated HF and 2 mL concentrated HNO₃. Then, after complete drying, the acid digested samples were re-digested for 8 hours at 90 -100° C. in a mixture of 1 mL concentrated HNO₃, 1 mL 30 - 32% H₂O₂, and 5 mL DI water. After re-digestion, the samples were diluted by 1% HNO₃ for further analysis. To quantify the acid-extractable REEs content, CFA samples (0.1-0.5 g) were digested in 10 ml concentrated HNO₃ at 85-90° C. for 4 hours. The digested samples were diluted with 1% HNO₃ for further analysis. The concentration of the REEs and impurities in the digested solutions were analyzed by inductively coupled plasma optical emission spectroscopy (ICP-OES, PerkinElmer Optima 7300 DV).

### Characterization of Liquid Samples

The concentration of HNO₃ in the TBP-HNO₃ complex was determined by acid-base titration with 0.1 M NaOH until the pH equaled 7.

To quantify the REE and impurity concentrations in each stripped solution collected from the ten-stage stripping process under _{SC}CO₂, _{SC}N₂, scAir, and heating only condition, they were diluted with 1% nitric acid and measured using ICP-OES. The REEs purity is calculated using Equation 2:

$$\begin{matrix}R E E p u r i t y = \\ \frac{{m}_{L a} + {m}_{C e} + {m}_{P r} + {m}_{N d} + {m}_{P m} + {m}_{S m} + {m}_{E u} + {m}_{G d} + {m}_{T b} + {m}_{D y} + {m}_{H o} + {m}_{E r} + {m}_{T m} + {m}_{Y b} + {m}_{L u} + {m}_{S c} + {m}_{Y}}{{m}_{t o t a l e l e m e n t}} \times \\ 100 \% ,\end{matrix}$$

where mₜₒₜₐₗ ₑₗₑₘₑₙₜ is the sum of all the measured elements in the stripping solution.

The higher purity of the REEs produced according to the processes of the present disclosure decreases the cost and process complexity that is otherwise needed to obtain a high purity REEs product.

To study the selectivity mechanism, the reacted TBP-HNO₃ samples obtained from the extraction were digested to quantify the amount of REEs and impurities which had complexed with TBP. The digestion of liquid TBP-HNO₃ samples was performed according to standard procedures known in the art. TBP-HNO₃ solutions was mixed with 1 mL DI water, 2 mL concentrated HNO₃, 0.4 mL 30 - 32% H₂O₂, and 0.4 mL concentrated HF. Then, an eight steps digestion for 1 hour in total at 100° C. was applied. After the digestion, the samples were diluted by 1% HNO₃ and prepared for ICP-OES analysis. The analysis results for various extraction conditions are shown in Tables 1-5.

Table 1. Concentrations of majority impurities (Ca, Fe, Mg, Al, Si) and total REEs in the stripping solutions collected from the first stage stripping process under _{SC}CO₂ conditions through a ten stage stripping process. The REEs purity was calculated by Eq. 2 for each collected stripping solution. Triplicate experiments were conducted and standard errors from triplicates were within 10%.

| | | | | | | | | | | |
|---|---|---|---|---|---|---|---|---|---|---|
| | 1 | 2 | 3 | 4 | 5 | 6 | 7 | 8 | 9 | 10 |
| Ca (mg·L⁻¹) | 18890.8 | 9620.0 | 1206.0 | 246.6 | 138.6 | 74.2 | 33.4 | 18.9 | 14.9 | 8.3 |

| | | | | | | | | | | |
|---|---|---|---|---|---|---|---|---|---|---|
| Fe (mg·L⁻¹) | 20693.9 | 13136.6 | 492.5 | 313.8 | 200.2 | 132.6 | 34.5 | 27.8 | 25.9 | 20.9 |
| Mg (mg·L⁻¹) | 626.2 | 83.1 | 0.0 | 0.0 | 0.0 | 0.0 | 0.0 | 0.0 | 0.0 | 0.0 |
| Al (mg·L⁻¹) | 174.5 | 3.0 | 0.0 | 0.0 | 0.0 | 0.0 | 0.0 | 0.0 | 0.0 | 0.0 |
| Si (mg·L⁻¹) | 0 | 0 | 0 | 0 | 0 | 0 | 0 | 0 | 0 | 0 |
| REEs (mg·L⁻¹) | 33.3 | 31.8 | 26.9 | 21.4 | 16.1 | 11.4 | 6.4 | 3.9 | 4.4 | 3.2 |
| REEs purity (%) | 0.1 | 0.2 | 1.4 | 3.4 | 6.5 | 6.3 | 7.2 | 5.7 | 7.0 | 6.0 |

Table 2. Concentrations of majority impurities (Ca, Fe, Mg, Al, Si) and total REEs in the stripping solutions collected from the first stage stripping process under heating only conditions through a ten stage stripping process. The REEs purity was calculated by Eq. 2 for each collected stripping solution. Triplicate experiments were conducted and standard errors from triplicates were within 10%.

| | | | | | | |
|---|---|---|---|---|---|---|
| | 1 | 2 | 3 | 4 | 5 | 6 |
| Ca (mg·L⁻¹) | 52666.1 | 13242.9 | 3947.3 | 590.3 | 255.4 | 145.6 |
| Fe (mg·L⁻¹) | 15752.6 | 11655.6 | 3786.0 | 734.1 | 428.3 | 604.3 |
| Mg (mg·L⁻¹) | 15561.3 | 350.1 | 95.3 | 9.7 | 1.6 | 0.8 |
| Al (mg·L⁻¹) | 8820.6 | 1781.8 | 611.8 | 152.8 | 80.8 | 77.2 |
| Si (mg·L⁻¹) | 0.0 | 0.0 | 0.0 | 0.0 | 0.0 | 0.0 |
| REEs (mg·L⁻¹) | 14.8 | 33.8 | 33.1 | 21.7 | 21.2 | 15.9 |
| REEs purity (%) | 0.0 | 0.1 | 0.3 | 1.1 | 1.9 | 1.3 |

Table 3. Concentrations of majority impurities (Ca, Fe, Mg, Al, Si) and total REEs in the stripping solutions collected from the first stage stripping process under scN₂ conditions through a ten stage stripping process. The REEs purity was calculated by Eq. 2 for each collected stripping solution. Triplicate experiments were conducted and standard errors from triplicates were within 10%.

| | | | | | | | | | | |
|---|---|---|---|---|---|---|---|---|---|---|
| | 1 | 2 | 3 | 4 | 5 | 6 | 7 | 8 | 9 | 10 |
| Ca (mg·L⁻¹) | 45398.4 | 8056.2 | 1634.3 | 291.2 | 38.2 | 25.0 | 5.2 | 1.1 | 2.4 | 1.2 |
| Fe (mg·L⁻¹) | 24101.3 | 7965.5 | 2187.6 | 400.2 | 151.1 | 92.3 | 43.8 | 16.4 | 25.2 | 17.5 |
| Mg (mg·L⁻¹) | 5988.8 | 435.2 | 10.1 | 0.0 | 0.0 | 0.0 | 0.0 | 0.0 | 0.0 | 0.0 |
| Al (mg·L⁻¹) | 1011.1 | 348.6 | 15.1 | 7.4 | 0.0 | 0.0 | 0.0 | 0.0 | 0.0 | 0.0 |
| Si (mg·L⁻¹) | 0.0 | 0.0 | 0.0 | 0.0 | 0.0 | 0.0 | 0.0 | 0.0 | 0.0 | 0.0 |
| REEs (mg·L⁻¹) | 23.8 | 35.4 | 33.8 | 25.2 | 16.7 | 11.7 | 6.4 | 2.2 | 4.7 | 2.8 |
| REEs purity (%) | 0.0 | 0.2 | 0.9 | 3.4 | 8.0 | 8.9 | 8.0 | 4.8 | 8.5 | 6.2 |

Table 4. Concentrations of majority impurities (Ca, Fe, Mg, Al, Si) and total REEs in the stripping solutions collected from the first stage stripping process under scAir conditions through a ten stage stripping process. The REEs purity was calculated by Eq. 2 for each collected stripping solution. Triplicate experiments were conducted and standard errors from triplicates were within 10%.

| | | | | | | | | | | |
|---|---|---|---|---|---|---|---|---|---|---|
| | 1 | 2 | 3 | 4 | 5 | 6 | 7 | 8 | 9 | 10 |
| Ca (mg·L⁻¹) | 38356.7 | 7676.1 | 1901.3 | 149.0 | 104.5 | 96.7 | 2.4 | 0.0 | 0.0 | 0.0 |
| Fe (mg·L⁻¹) | 20943.5 | 8224.8 | 1808.4 | 317.1 | 200.3 | 229.6 | 121.0 | 97.6 | 65.4 | 51.6 |
| Mg (mg·L⁻¹) | 6272.0 | 280.1 | 6.1 | 1.0 | 0.0 | 0.0 | 0.0 | 0.0 | 0.0 | 0.0 |
| Al (mg·L⁻¹) | 2294.6 | 188.5 | 23.7 | 2.1 | 0.5 | 0.3 | 0.0 | 0.0 | 0.0 | 0.0 |
| Si (mg·L⁻¹) | 0.0 | 0.0 | 0.0 | 0.0 | 0.0 | 0.0 | 0.0 | 0.0 | 0.0 | 0.0 |
| REEs (mg·L⁻¹) | 23.0 | 29.1 | 25.3 | 13.9 | 13.4 | 9.9 | 5.3 | 5.6 | 3.5 | 2.3 |
| REEs purity (%) | 0.0 | 0.2 | 0.9 | 3.5 | 4.1 | 2.8 | 3.8 | 4.8 | 3.5 | 2.9 |

Table 5. Total summed concentrations of impurities in ten-stage stripping solution under different supercritical state of CO₂, N₂, air, and their mixture and heating only conditions. Triplicate experiments were conducted and standard errors from triplicates were within 10%.

| | Ca (mg/L) | Fe (mg/L) | Mg (mg/L) | Al (mg/L) |
|---|---|---|---|---|
| 150 N₂ | 55443.4 | 34897.9 | 6434.1 | 1382.1 |
| 120 N₂ | 55609.0 | 37960.6 | 9805.0 | 1847.0 |
| 150 Air | 48286.8 | 32059.3 | 6559.2 | 2509.8 |
| 120 N₂ + 30 CO₂ | 41830.9 | 30338.4 | 5203.8 | 783.8 |
| CO₂ | 30251.5 | 35603.8 | 709.3 | 177.56 |
| Heat | 70847.6 | 32960.8 | 16018.8 | 11524.9 |

### Calculating the Fates of REEs/Impurities

In order to investigate how the SCF enhanced the selective extraction of REEs over impurities, the fates of REEs and impurities during the extraction process were separated into three types: unextracted, uncollected, and collected, and then calculated as shown in Equations 3-5:

$$U n e x t r a c t e d \left(\%\right) = \frac{w t {\%}_{r} \times {m}_{r}}{w t {\%}_{u} \times {m}_{u}} \times 100 \% ,$$

$$C o l l e c t e d \left(\%\right) = \frac{{\sum }_{i = 0}^{n} V \times {m}_{i s}}{w t {\%}_{u} \times {m}_{u}} \times 100 \% ,$$

$$U n c o l l e c t e d \left(\%\right) = 1 - U n e x t r a c t e d \left(\%\right) - C o l l e c t e d \left(\%\right) ,$$

where wt%ᵤ is the mass percentage of the REEs/impurities in the unreacted CFA, which was determined by ICP-MS after total digestion of unreacted CFA; mᵤ is the mass of unreacted CFA; wt%ᵣ is the mass percentage of the REEs/impurities in the reacted CFA, which was determined by ICP-MS after total digestion of the reacted CFA; mᵣ is the mass of reacted CFA; i is the stripping stage number; n is the total number of stripping stages (6 for the heating-only condition, and 10 for _{SC}CO₂, _{SC}N₂, and scAir conditions); v is the volume of the stripped solution collected in each stripping stage (1 mL in this process); and mᵢₛ, is the concentrations of the REEs/impurities in stripped solution collected from ith stripping stage which is determined by ICP-OES.

### Characterization of Coal Fly Ash Samples

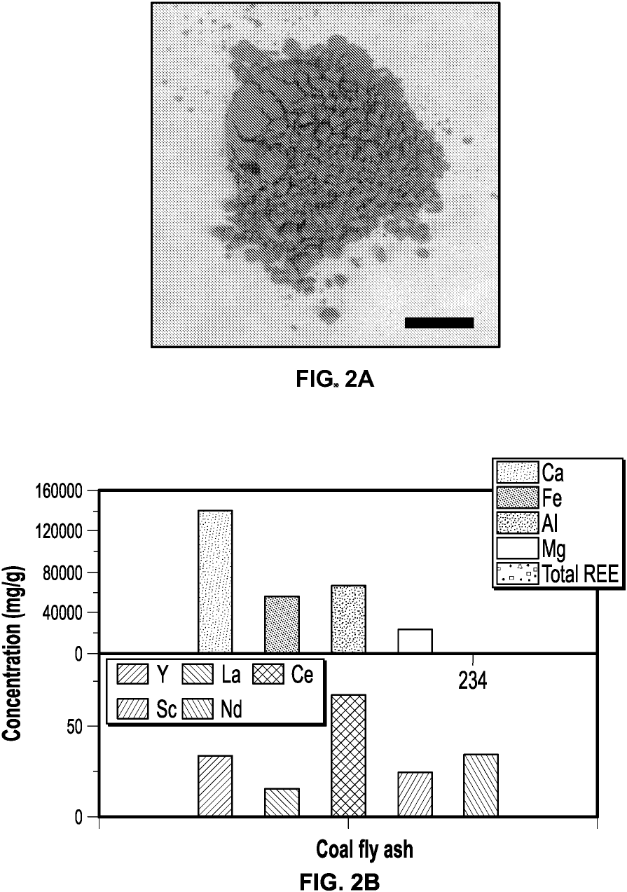

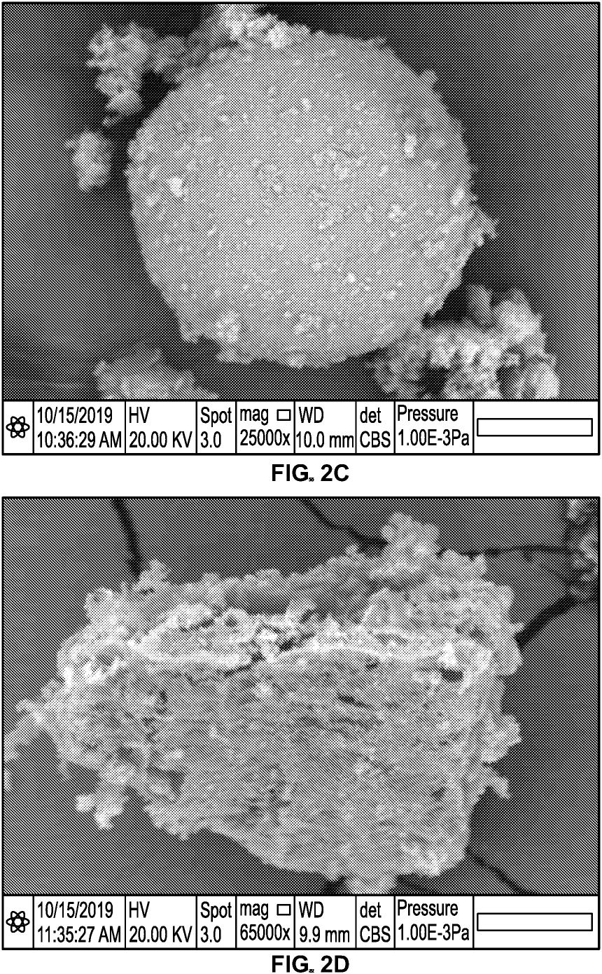

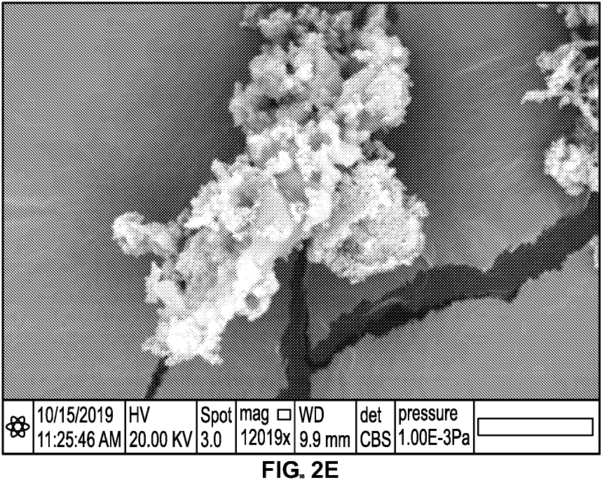

FIG. 2A shows the dark brownish particles of CFA used in this study. The chemical composition of CFA was characterized by ICP-OES after HF-HNO₃ and HNO₃-H₂O₂ sequential digestion (FIG. 1B), and by X-ray fluorescence spectroscopy (Tables 6 and 7). As shown in FIG. 2B, the total REEs content was 234 ± 2.3 ppm in the sample, which is within the reported range of total REEs contents in U.S.-based coal fly ashes. Cerium (Ce) was present at 60 ppm, the highest concentration among all REEs. In addition, the sample had high concentrations of Y and Nd, elements which face a projected severe supply risk by 2035.

Table 6. The major element composition in coal fly ash analyzed by X-ray Fluorescence spectroscopy.

| Maj or elements | wt% |
|---|---|
| K₂O | 0.91 |
| CaO | 27.49 |
| TiO₂ | 0.58 |
| MnO | 0.20 |
| Fe₂O₃ | 7.15 |
| Na₂O | 0.4 |
| MgO | 6.7 |
| Al₂O₃ | 12.2 |
| SiO₂ | 23.6 |
| P₂O₅ | 0.12 |
| Loss on ignition | 20.5 |

Table 7. The minor element concentration in coal fly ash analyzed by X-ray Fluorescence spectroscopy.

| Minor elements | mg^{∗}kg⁻¹ |
|---|---|
| Y | 36 |
| Sr | 2113 |
| Rb | 53 |
| Pb | 248 |
| Ce | 113 |
| Nd | 42 |
| La | 54 |
| Ba | 5917 |

However, the ICP-OES results after the digestion also showed that the CFA has a variety of high concentration impurities, including Ca (138,710 ppm), Fe (54,943 ppm), Al (66,149 ppm), and Mg (23,306 ppm). The relatively abundant alkaline oxides (16.72% CaO and 3.6% MgO), rather than an enrichment in A1₂O₃ and Fe₂O₃, indicates that the CFA is a Class C CFA, which has been proven to exhibit higher REE extractability. However, the 2-3 orders of magnitude difference between REEs and impurity concentrations clearly emphasizes the challenge in selectively extracting REEs.

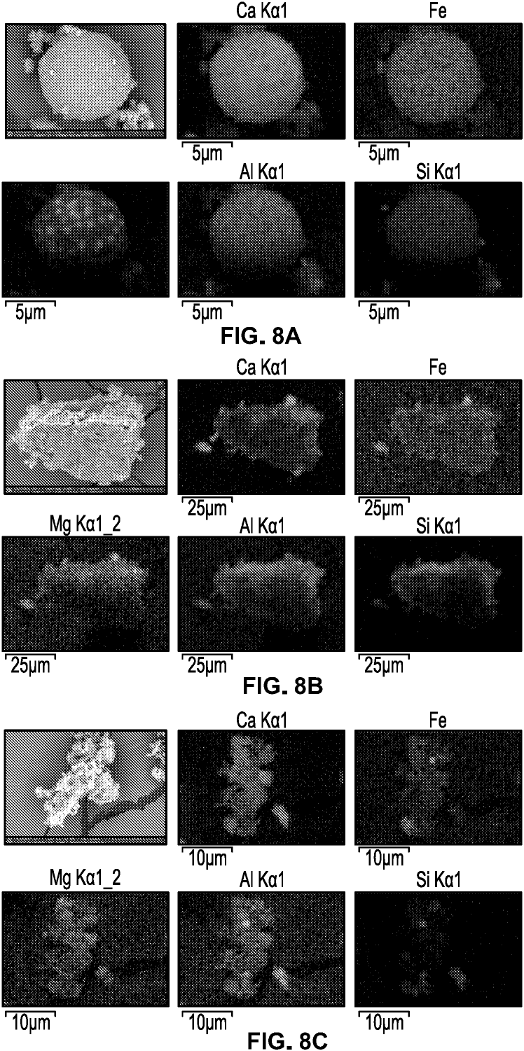

During coal combustion, heating in excess of 1400° C. and rapid cooling in the post-combustion stage cause a diverse size distribution and morphology of fly ash, such as solid spheres, layered particles, and aggregated particles, shown in FIGS. 2C-2E. As determined by energy-dispersive X-ray (EDX), the predominant elements over the fly ash samples were silicon, calcium, aluminum, iron, and magnesium (FIGS. 8A-8C), which was consistent with ICP-OES results. The REEs′ concentrations were lower than the detection limit for EDX.

The composition of the TBP-HNO₃ complex has been shown to significantly affect the REEs extraction efficiency. Using acid base titration, the extractant was identified to be TBP(HNO₃)_{1.67}, which is close to the nitric acid content reported in the literature.

### Successful Extraction of REEs With _{SC}CO₂, scN₂, and scAir

To achieve a more environmentally benign and highly selective supercritical fluid extraction (SFE) of REEs, previous studies have suggested to use TBP-HNO₃ as an extractant to complex with REEs to form a highly supercritical CO₂ soluble molecule. Although the successful extraction was implemented on REEs oxides and postconsumer products, little is known about whether this mechanism will still work when abundant impurities are present, such as the case of CFA. Therefore, after reacting the CFA with TBP-HNO₃ under SCF as FIG. 1B depicts, the REEs extraction efficiency was determined using Equation 1.

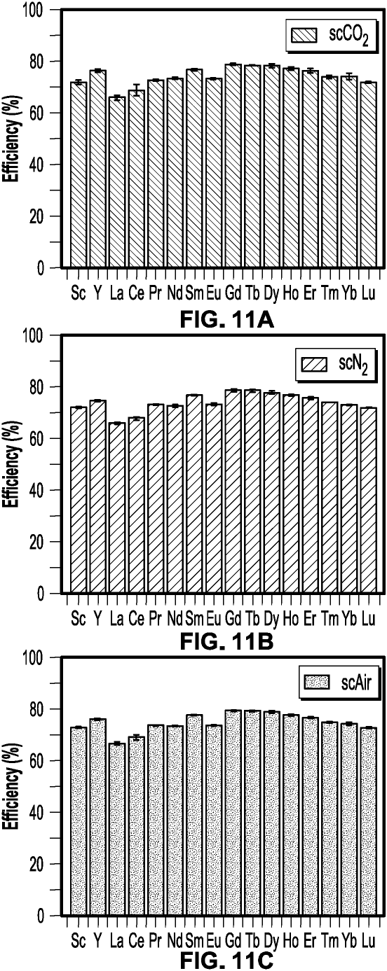

The efficiencies for all REEs (scandium, yttrium, and 17 lanthanides) are shown in FIG. 11A. For the REEs with high concentrations in the CFA, the efficiencies obtained are 76% Y, 66% La, 69% Ce, 79% Gd, and 73% Nd. The composition of TBP-HNO₃, which has shown to affect the extraction efficiency, was identified to be TBP(HNO₃)_{1.67}, which is close to the nitric acid content reported in the literature. Notably, even though the REEs in the CFA coexisted with much higher concentrations of impurities, the extraction efficiencies (~70%) were comparable to the extraction efficiencies (40 - 99%) in other studies, where concentrated REEs sources were used. These surprising results clearly demonstrate that utilizing _{SC}CO₂ with TBP-HNO₃ to extract REEs from CFA offers promising efficiency.

In previous SCF applications, the most widely used SCF was supercritical CO₂ (_{SC}CO₂) because of its moderate critical points (T_{c} = 304.25 K, P = 73.8 bar). In order to expand the sources for supercritical fluid extraction to more accessible gases, extraction experiments were conducted using supercritical nitrogen (scN₂) and supercritical air (scAir) for the first time. For a proper comparison, the same pressure and temperature (323.15 K and 150 bar) were maintained for the scN₂ and scAir systems, which are higher than the critical temperature and pressure for N₂ (126.19 K and 34.0 bar) and air (132.63 K and 37.9 bar). Surprisingly, as FIGS. 11B and 11C show, the extraction efficiency for all REEs are still within the range of 66 - 79%. This finding demonstrates that scN₂ and scAir are applied in SCF extraction and do not inhibit the reaction between REEs and TBP-HNO₃.

### SCF-enhanced Selective Extraction of REEs Over Impurities

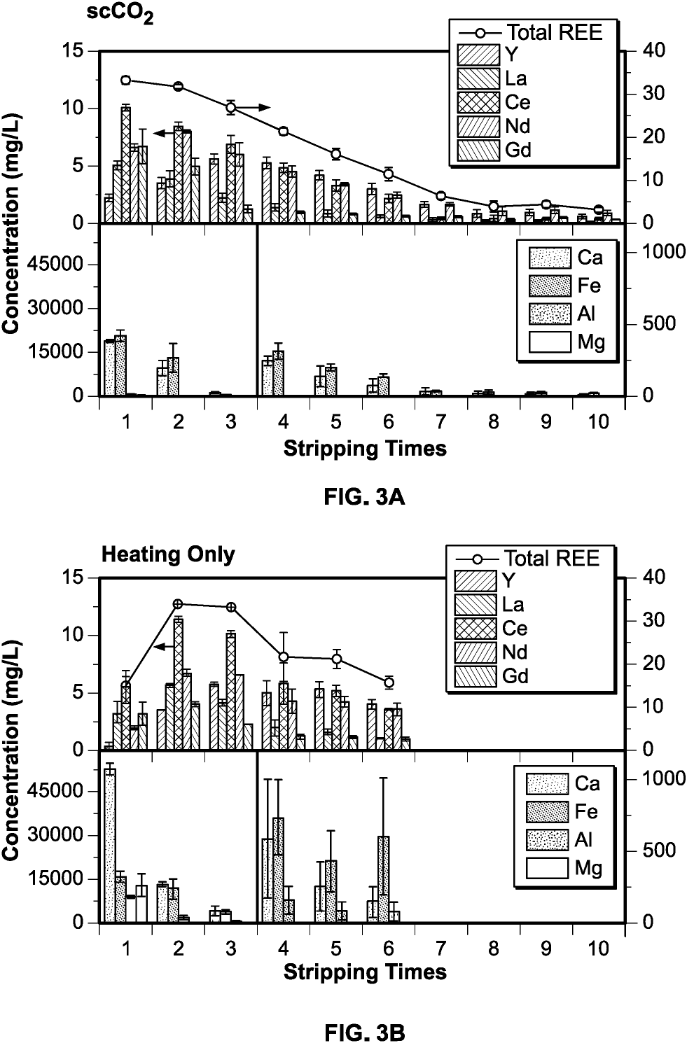

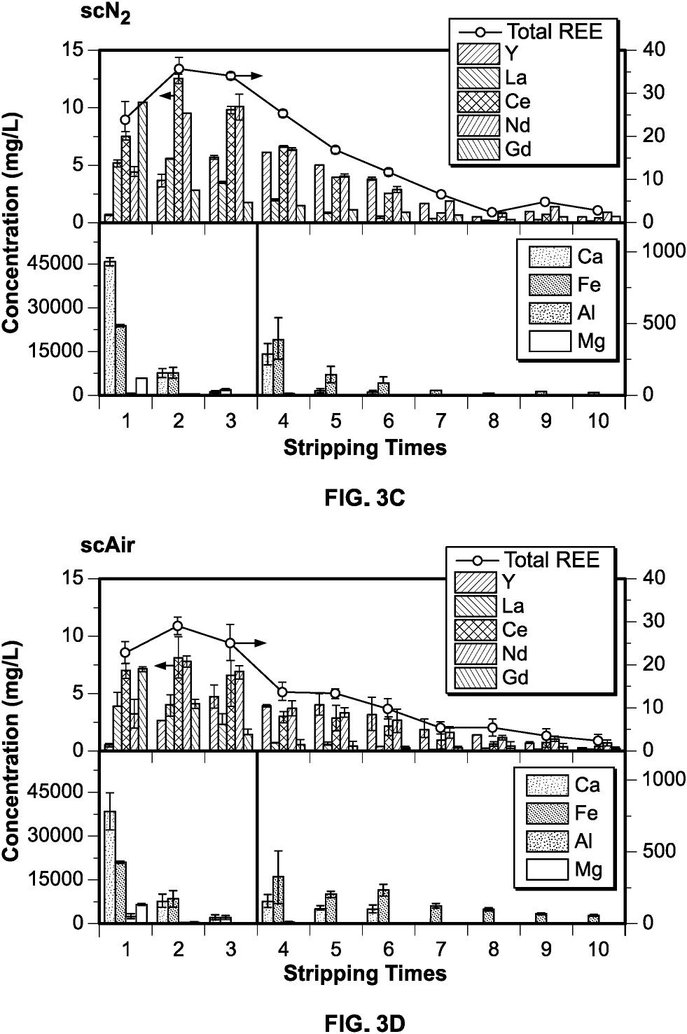

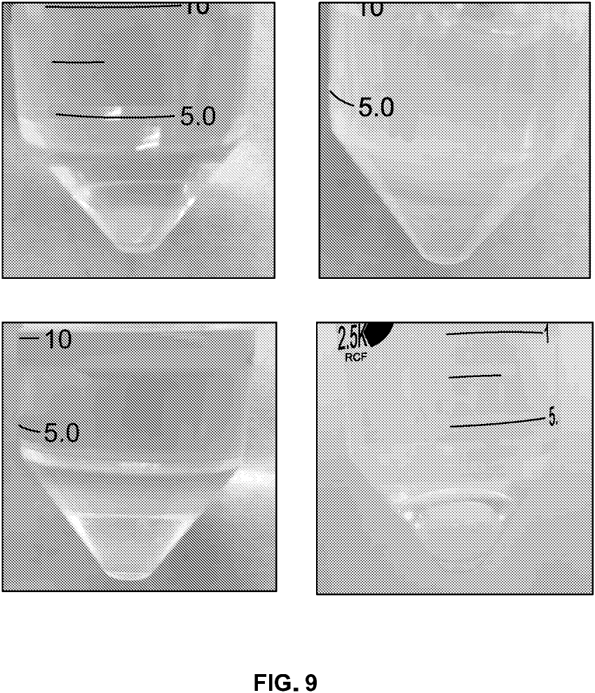

After confirming that REEs were successfully extracted from CFA, they were collected from the reacted TBP-HNO₃. A multistage stripping process using 1% nitric acid was applied, as depicted in FIG. 1C. To evaluate the effect of SCF, a control experiment was performed in which the CFA were reacted with TBP-HNO₃ at 50° C. and in the absence of SCF (heating only condition). For SCF conditions, a ten-stage stripping process was applied to collect as many REEs as possible. For the heating only condition, however, the optically fuzzy interface between reacted TBP-HNO₃ and 1% nitric acid (FIG. 9B) after six stripping stages prevented further application of more stripping stages. During each stripping stage, REEs and impurities were dissociated with TBP and then dissolved in the 1% nitric acid. Ca, Mg, and Fe have been shown to have much higher water affinity compared to REEs and thus they will preferred to be removed from reacted TBP-HNO₃ during the early stripping stage. As FIG. 3 shows, due to their different water affinity, REEs were gradually dissociated with TBP and then collected by 1% nitric acid from the first stage stripping through the six stage stripping while impurities were mostly collected in the first and second stage stripping to achieve a partial separation between REEs and impurities. The total REEs concentrations in the first through sixth stages were ranged from 11 to 35 mg/L under SCFs conditions (FIGS. 3A, 3C, 3D) which is much higher than the reported concentrations of REEs extracted from CFA (0.3-5.5 mg/L) in previous studies. However, under heating only condition, the collected REEs in the stripped solutions were also within the range of 10-35 mg/L. In previous studies, the high diffusivity of _{SC}CO₂ facilitated the transport of TBP-HNO₃ into the center of REEs matrix and thus significantly promoted the extracted REEs amount. Nevertheless, the present results indicate that, with the little content of REEs and porous structure, CFA allows the extractant to react with all the REEs even without the assistance of SCF.

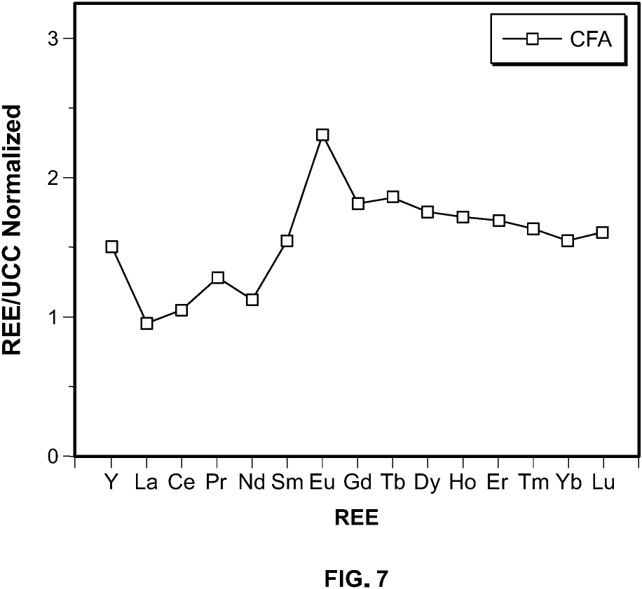

FIG. 7 shows the relative enrichment of each REE in a CFA sample compared to the REE concentrations in the Earth crust. A larger number indicates higher relative enrichment.

Surprisingly, although SCFs have little impact on enhancing REEs concentration, they significantly decreased the impurities concentrations in the stripped solution. In the first stripped solution, comparing the up to 52,666 ppm Ca, 15,561 ppm Mg and 8,821 ppm Al (FIG. 3B) under heating only condition, the concentrations of Ca, Mg and Al were decreased to only 18,891 ppm, 626 ppm, and 175 ppm (_{SC}CO₂, FIG. 3A), 45,398 ppm, 5,989 ppm, and 1,011 ppm (scN₂, FIG. 3C) and 38,357 ppm 6,272 ppm, and 2,295 ppm (scAir, FIG. 3D), respectively. In the later collected stripped solutions obtained under SCFs, the concentrations of impurities were also much lower than those under the heating only condition. For example, while the collected stripped solution from the fourth stage under heating only still contained 590 ppm Ca, 734 ppm Fe, and 152 ppm Al, the one under the _{SC}CO₂ condition contained only 247 ppm Ca, 314 ppm Fe, and no Al. Harnessing the different water affinity and SCF’s effect in decreasing impurities concentrations, the present multistage stripping process could significantly improve the purity of REEs and ultimately achieve a selective extraction of REEs over impurities. Further, compared with CO₂ and water, nitrogen and air have been less investigated in their supercritical states and nitrogen is even commonly considered as inert. For the first time, this study surprisingly demonstrates that supercritical nitrogen and air were applied in SFE extraction of REEs, and their application results in a greatly decreased amount of impurities. In addition, a mixture of supercritical nitrogen and non-supercritical CO₂ was tested, which performed well in concentrating REEs and decreasing impurities.

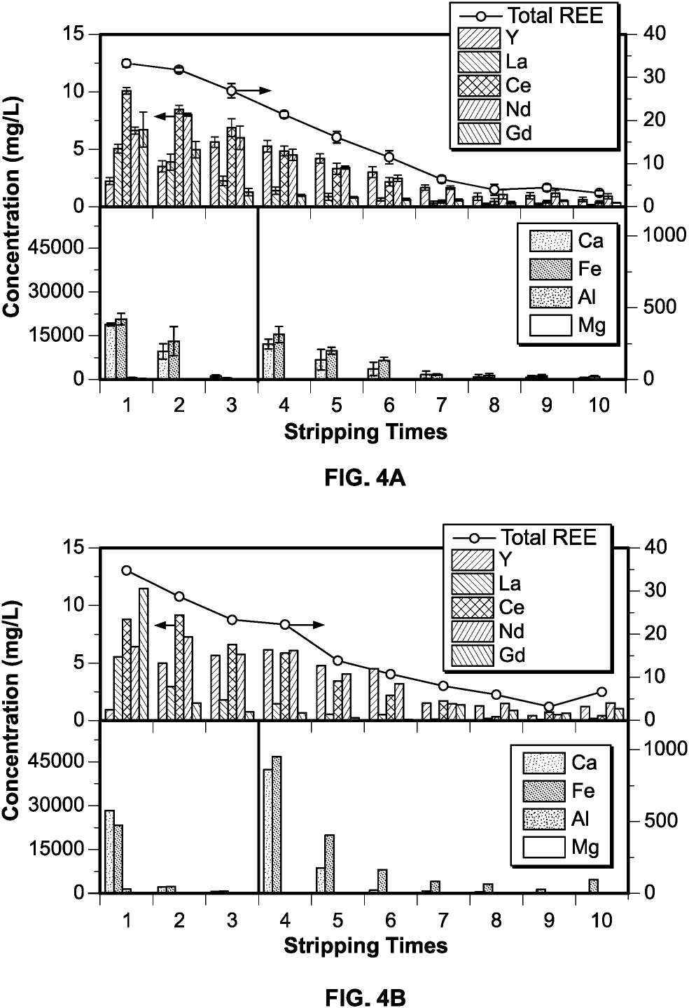

Also surprisingly, it was demonstrated that TBP-HNO₃ could be regenerated and reused. This regenerated TBP-HNO₃ was effective in subsequent stripping processes and comparable in performance to fresh TBP-HNO₃ (FIGS. 4A and 4B). As shown in FIG. 4B, the total REEs concentrations in stripping solutions from the first stage stripping through the tenth stage stripping are still within 10 - 35 mg/L, with little difference from the stripping results using freshly made TBP-HNO₃. As expected, distribution of impurities concentrations in ten stage stripping solutions for regenerated TBP-HNO₃ follow a similar trend as the fresh TBP-HNO₃ results.

### SCF-extractant Interaction Enhances REEs Selectivity

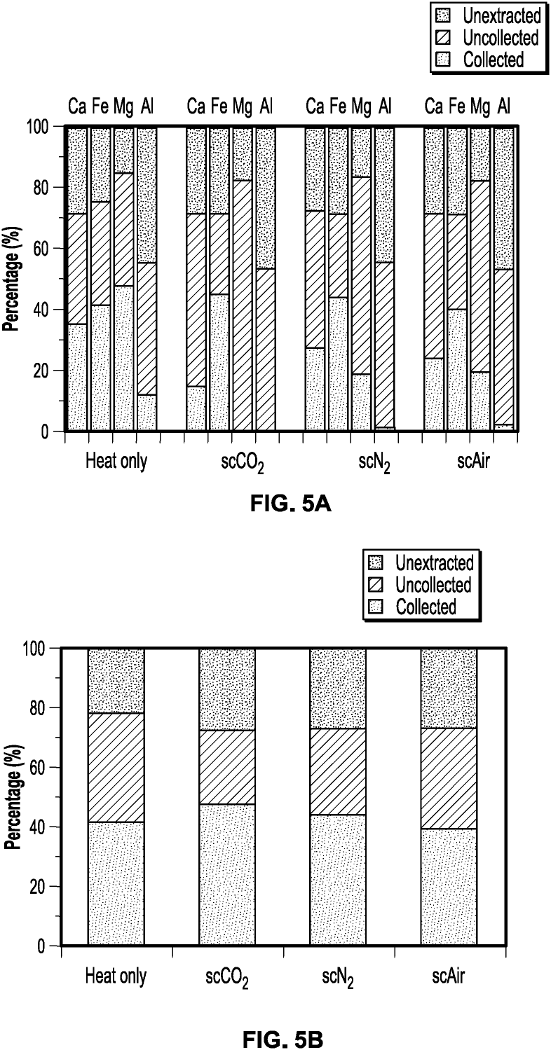

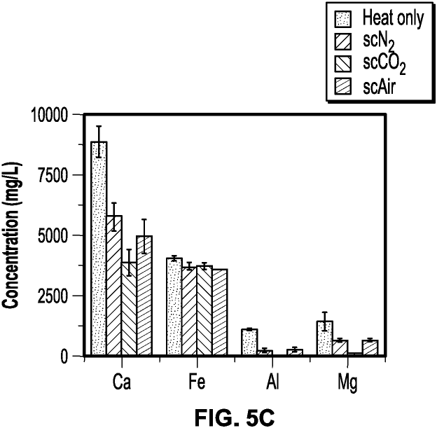

In order to understand the mechanisms behind the selective extraction of REEs from CFA, the fate of REEs and impurities during the entire process was investigated. As shown in FIGS. 5A and 5B, the REEs/impurities in these experiments have three fates: unextracted portion, uncollected portion, and collected portion. The unextracted portion of the REEs/impurities is the non-acid-extractable portion, which is dependent on their species. For example, previous studies showed that a REEs-bearing glass phase was hardly dissolved in an acidic solution. It was presently observed that the minority of REEs and impurities remained in the CFA and, more importantly, that the unextracted portions were unaffected regardless of the presence of SCFs. Therefore, the selective extraction of REEs over impurities happened after the REEs/impurities’ initial dissolution from CFA. The red parts (collected portion) in FIGS. 5A and 5B represent the REEs/impurities dissolved in the stripped solution collected from the ten-stage stripping process. While the collected portions of REEs and Fe were close under different conditions, it was observed that the collected Ca, Al, and Mg portions decreased significantly under SCF conditions compared to the heating-only condition. In detail, 35.6% of the total Ca, 47.9% of Mg, and 12% of Al were collected in the stripped solution under the heating-only condition. Considering the enormous amounts of impurities in the CFA, the purity of the REEs that were collected under the heating-only condition was very poor. In sharp contrast, the collected portions of Ca, Mg and Al decreased respectively to 15.2%, 2.1%, and 0.2% (_{SC}CO₂), to 27.8%, 19.3%, and 1.5% (_{SC}N₂), and to 24.2%, 19.6%, and 2.6% (scAir), respectively. Hence, the SCFs have a substantial impact on the third fate of REEs/impurities: uncollected portions, which describes those REEs/impurities that were not collected in the 1% nitric acid after leaching from the CFA.

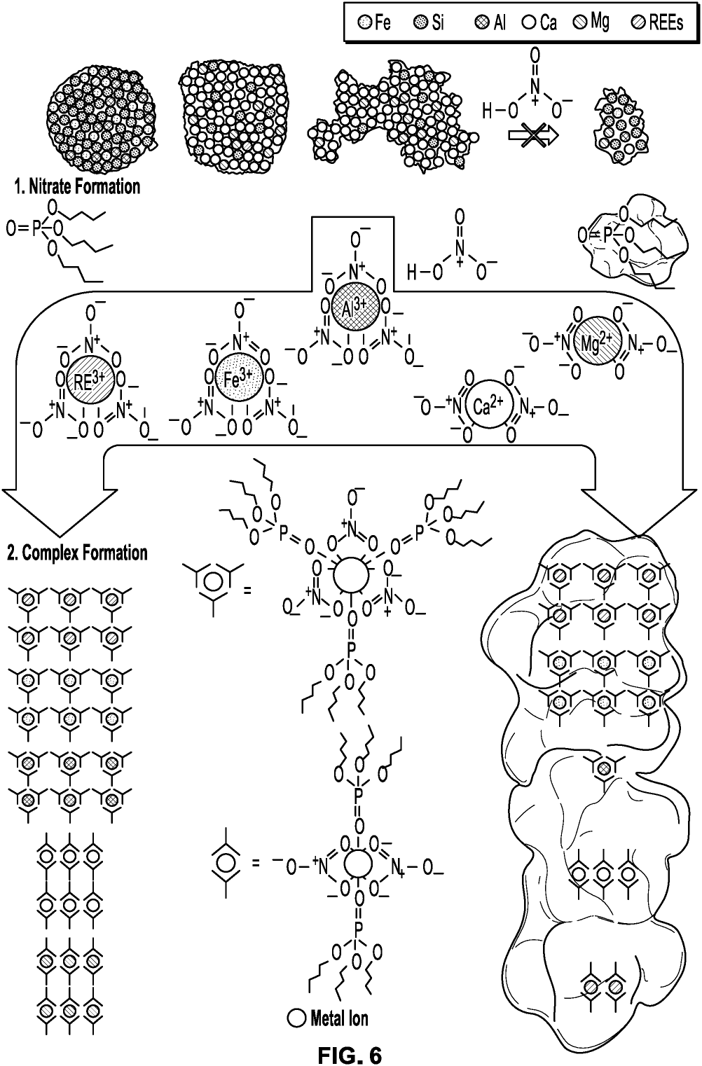

The reaction between metal and TBP-HNO₃ contains two-steps. The first step is that metals are dissolved by nitric acid to form metal nitrate salts. The second step is that the metal nitrate salts further react with TBP to form the complexes. In order to study how SCFs affect the uncollected portions, the reacted TBP-HNO₃ was digested before applying the multistage stripping process, and then ICP-OES was used to quantify how many REEs/impurities complexed with TBP under different conditions. As FIG. 5C shows, Ca, Mg, and Al complexed less favorably with TBP under SCF conditions than under heating-only condition, while the SCF had little effect on the complexation between Fe and TBP. Under the SCFs, impurities including Ca, Mg, and Al failed to complex with TBP. Instead, they remained as metal nitrates to stay with unreacted solid residues and were washed away when the solid residues were rinsed before quantifying the unreacted REEs/impurities portion. Previous studies showed that the complexation capability of metal nitrates with TBP followed the series Fe > REEs >> Ca > Mg > Al. Combining this series with the present results, it was hypothesized that an interaction between TBP and the SCF lowers the reactivity of TBP. Only these metal nitrates that easily complex with TBP (REEs, Fe) still form complexes, while calcium nitrate, magnesium nitrate, and aluminum nitrate remain unchanged, even in the presence of TBP. Thus, a mechanism for the enhanced selective of REEs from CFA was proposed, shown in FIG. 6. Initially, most metal leaches from the CFA to form metal nitrates, leaving the non-acid extractable metals in the solid residues. When there is no SCF present, those metal nitrates just complex with TBP, and no REEs selectivity is achieved. However, under SCF conditions, while REEs nitrates and iron nitrate prefer to form complexes, only a little of the calcium nitrate, magnesium nitrate, and iron nitrate forms complexes with TBP, and thus the REEs are successfully separated from them. Thus, it was confirmed that SCF indeed changes the reactivity of TBP with different metal nitrates.

In past descriptions of selective extraction during SFE, the high selectivity is proposed to be achieved by two mechanisms. One is that the reaction rate is tailored by the temperature/pressure to adjust product solubility in SCF. The other is that the targeted metal and impurities form different complex structures and thus have different solubility in the SCF. In both mechanisms, SCF was only considered as a physical carrier and brought the product with high solubility in SCF to the collection vessels to achieve the selective extraction. However, in the present stagnant extraction system, SCF serves a solvent for the reaction between REEs/impurities and TBP-HNO₃ and does not have a chance to take the product away. Herein, it was confirmed that SCF has a new function in achieving selective extraction. Beyond serving as a physical carrier, the SCF also changes the reactivity of the extractant, thereby enabling greater selectivity. Though SCF has always been considered as an inert solvent during extraction, the present results suggest that SCF interacts with extractant and affect its properties. Additional computational and spectroscopic studies can further investigate how the extractant can be changed in the SCF.

### Determination of the Best Volume Ratio in Multistage Stripping Process For Concentrating REEs

To determine the optimal volume ratios of reacted TBP-HNO₃ and 1% HNO₃ (1:10, 1:1, 10:1, or 100:1) stripping solution, neodymium (Nd) was used as a model REE. For this optimization, two criteria were used for the evaluation: the REE concentration and the stripping efficiency, calculated as in Eq. 6.

$$\begin{matrix}S t r i p p i n g E f f i c i e n c y = \\ \frac{C o n c e n t r a t i o n o f R E E i n s t r i p p i n g s o l u t i o n \times s t r i p p i n g s o l u t i o n v o l u m e}{A m o u n t o f R E E a d d e d i n t o T B P \text{} - \text{} H N {O}_{3}} \times 100 \% ,\end{matrix}$$

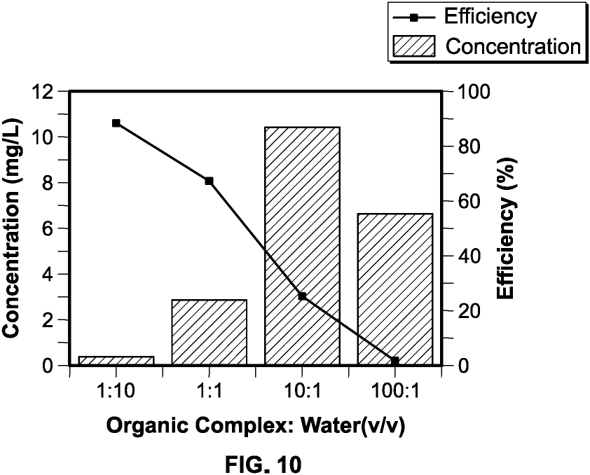

As FIG. 10 shows, the stripped Nd concentration and stripping efficiency demonstrate opposite trends at different TBP-HNO₃: 1% HNO₃ volume ratios. The stripping efficiencies decrease as the volume ratios decrease, suggesting that the distribution of REEs was determined by the volume ratio. When the volume ratio is 1:10, the efficiency is about 90%. When the volume ratio is 10:1, the stripping efficiency decreases to about 30%, however, Nd was significantly concentrated because of the small stripping solution volume. When the volume ratio is decreased to 100:1, the Nd concentration does not increase because Nd cannot enter the stripping solution. Thus, the volume ratio of 10:1 is optimal for concentrating REEs in this process. Further, in some embodiments, the reacted TBP-HNO₃ is stripped multiples times to collect the maximum amount of REEs into stripping solution.

### The Influence of Pressure and Different Compositions of Supercritical Fluids on Impurities Amounts

Unlike the pure substances _{SC}CO₂ and _{SC}N₂, scAir is a mixture of 78% N₂, 21% O₂, 0.93% Ar, 0.04% CO₂, and small amounts of other gases. To investigate the concentrations of impurities in the multistage stripping process under scAir conditions compared to those under scN₂ conditions, additional tests were performed, including using 120 bar nitrogen and using 120 bar N₂ with 30 bar CO₂ as SCF for REEs extraction. The concentrations of collected major impurities (Ca, Fe, Mg, Al) in stripping solutions from all ten stages stripping process were summed and listed in Table 5. By comparing the 150 bar N₂ and 150 bar air conditions, it was discovered that the Ca concentration is smaller while the Al concentration is higher in 150 bar air conditions. The opposite trend of Ca and Al suggests that different components in the air have a different influence on impurities concentrations, because 150 bar air can be considered as a mixture of approximate 120 bar N₂, 30 bar O₂, and trace amounts of CO₂ and other gases. A 120 bar N₂ experiment was first used to investigate the pressure effect on impurities concentration. At lower pressure, the concentration of all impurities increased compared to the 150 bar N₂ experiment. However, due to the higher Al concentration in 150 bar air condition compared to 120 bar N₂ condition, the addition of oxygen is adverse to decrease impurity concentration. In contrast, in some embodiments, the addition of CO₂ (120 bar N₂ with 30 bar CO₂), even when not in supercritical state, significantly decreases the impurities concentrations, especially the Al. Hence, different components in the air indeed affect the behavior of scAir in the extraction of impurities.

### Select Advantages of the Present Extraction Processes

The present process directly extracts REEs from the solid matrix, without the need for high temperature and copious amounts of acid. Moreover, using supercritical fluid, a “greener” solvent, this new process is less toxic and more environmentally friendly than organic solvent extraction.

The biggest challenge in recovering REEs from coal ashes is how to separate the REEs from the major impurities, because a low REEs purity rules out further beneficiation. In the present multistage stripping process, it has been shown that _{SC}CO₂ performs best in enriching REEs while also decreasing impurity concentrations, especially in the stripped solutions collected from the fourth through sixth stripping stages. Table 8 lists the REEs concentrations, major impurities concentrations, and REEs purity in these stripped solution stages and includes comparable results from other studies.

Table 8. Concentrations of major impurities and total REEs, and REEs purity in final products of the liquid emulsion membrane process, supported liquid membrane process, conventional organic solvent extraction process, and the present SCF extraction process.

| | Liquid Emulsion Membrane Final Liquid^{∗} | Supported Liquid Membrane Final Liquid^{∗} | Conventional extraction Final Liquid^{∗} | This work scCO₂ Fourth stripping solution | This work scCO₂ Fifth stripping solution | This work scCO₂ Sixth stripping solution |
|---|---|---|---|---|---|---|
| Na (µg·L⁻¹) | 333000 | 27900 | 4220 | 0 | 0 | 0 |
| Mg (µg·L⁻¹) | 8320 | 152 | 320 | 0 | 0 | 0 |
| Al (µg·L⁻¹) | 149000 | 1770 | 919000 | 0 | 0 | 0 |
| Fe (µg·L⁻¹) | 522 | 551 | 2100 | 313802 | 200196 | 132632 |
| Ca (µg·L⁻¹) | 107000 | 968 | 42700 | 246556 | 138580 | 74175 |
| Si (µg·L⁻¹) | 28900 | 5340 | 3450 | 0 | 0 | 0 |
| REEs (µg·L⁻¹) | 4635 | 303 | 5587 | 21374 | 16088 | 11441 |
| REEs purity(%) | 0.73 | 0.79 | 0.57 | 3.43 | 6.47 | 6.26 |

^{∗} Results are from Smith et al., “Selective Recovery of Rare Earth Elements from Coal Fly Ash Leachates Using Liquid Membrane Processes”, Environmental Science & Technology, 2019. REEs purity is calculated from Eq. 2.

Most notably, compared with the multiple impurities in other studies, only two impurities were found in the present product: Fe and Ca. Fewer impurity species can beneficially decrease further purification steps needed to obtain highly purified REEs. Also of note, the highest reported REEs concentration was collected, between 11,441 - 21,374 µg·L⁻¹; values which are 2 times to 70 times higher than other studies’ results. Further, a 6.47% REEs purity was achieved; nearly 10 times purer than reported elsewhere. For example, the purity in raw CFAs is only about 0.02%. The REEs purity in the present process is not only statistically higher, but also comparable to the purity of some commercially available REEs ores. This commercial purity suggests coal ashes indeed are a promising REEs source to counter the supply shortage.

### Conclusions.

Supercritical fluids including _{SC}CO₂, _{SC}N₂, and scAir have been applied to selectively extract rare earth elements directly from solid coal fly ash matrix. Even though major impurities such as Ca, Fe, Al, and Mg have several magnitudes higher concentrations in CFA than REEs, REEs were nevertheless extracted, thereby greatly decreasing the impurity amounts in the final product. This result confirms that SCF can alter the reactivity of the extractant (such as tributyl phosphate (TBP)) and make it less capable of forming complexes with impurities. The result also emphasizes the importance of previously neglected SCF-solute interactions. Through this mechanism, the highest REEs concentration and highest REEs purity on extracting REEs from CFA was obtained. Using an environmentally-friendly solvent, the present process generates valuable and critical resources from previously considered waste.

### Example 2 Further Demonstrations of the Extraction Process

Example 1 demonstrated the use of supercritical CO₂, nitrogen, and air with tributyl phosphate - nitric acid (TBP-HNO₃) to extract REEs directly from a CFA. This example expanded the range of supercritical fluids to include more accessible gas species, such as air and nitrogen, and found they can interact with the extractant to enhance the selectivity for REEs over impurities.

The present example furthers the demonstration of Example 1. First, the process is tested on different CBRs to evaluate its performance in selectively extracting REEs when different impurities are present. Second, the process is further investigated to improve the purity and concentrations of collected REEs. Third, the process is evaluated to minimize the usage of the extractant and to generate zero organic waste. Achievement of these goals can promote the industrial development of the SCF extraction process for REEs recovery due to the green chemistry and the high selectivity and concentration.

This example presents an improved process for recovering REEs from CBRs, including SCF extraction, multistage stripping, and extractant regeneration. The process uses supercritical carbon dioxide and TBP-HNO₃ to extract REEs from different CBRs. By utilizing the extractant’s inherent selectivity, further enhanced by the SCF-extractant interaction, impurities like Si, Al, and Mg are first removed from REEs. Then, harnessing the different water affinities of the remaining impurities (mostly Ca and Fe) and REEs, impurities and REEs were collected in different stages during multistage stripping at room temperature, using only diluted acid. This facile and chemically simple process effectively separates REEs from background impurities, and it works well with CBRs from three different sites. After implementing green chemistry, the remaining step is to regenerate the extractant for reuse. By replacing organic solvent with SCF and directly extracting REEs from solid phase CBRs, the process minimizes the usage and generation of organic chemicals and consumes less energy. Ultimately, the process is a strong candidate for selectively extracting REEs from CBRs because it is environmentally friendly, high yielding, and highly selective.

### Supercritical Fluid-Assisted REEs Extraction

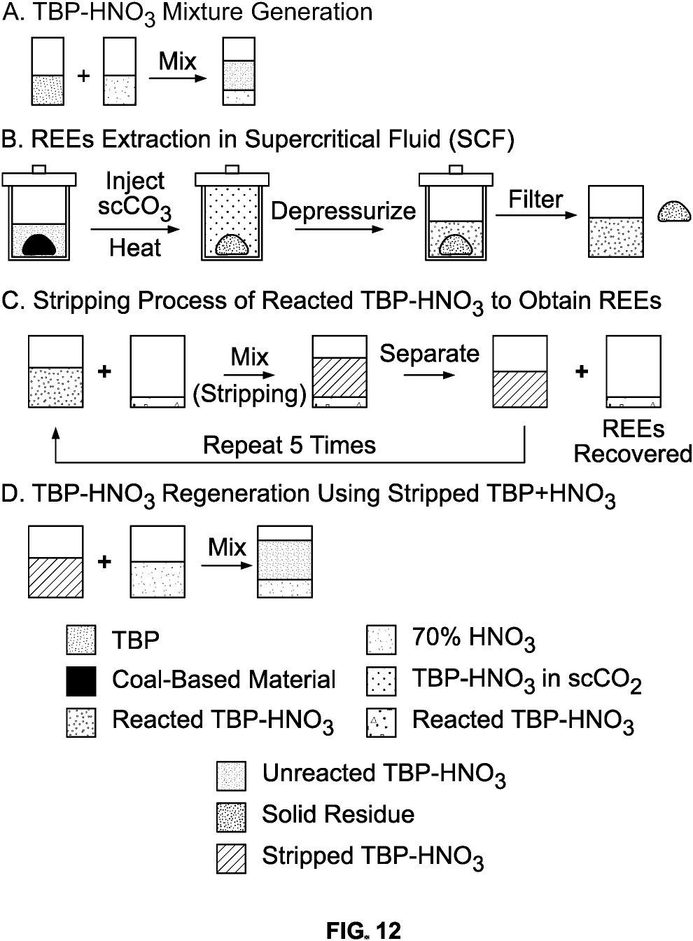

Described herein is a process that utilizes supercritical fluids (SCF) to selectively extract rare earth elements (REEs) from coal-based resources (CBRs). There are five used CBRs. Coal, bottom ash (BA), and coal fly ash-Missouri (CFA-M) came from a power plant in Missouri that burns Powder River Basin (PRB) coal. Coal fly ash-Kentucky (CFA-K) and coal fly ash-Texas (CFA-T) were collected from coal-fired power plants burning coal from the Appalachian Basin and PRB, respectively. This Example used deionized water (18.2 MΩ-cm) from a Barnstead Ultrapure Water System (D11931, Thermo Scientific) and American Chemical Society grade chemicals. The REEs extraction process has four steps, shown in FIG. 12. The first step is to generate tributyl phosphate - nitric acid (TBP-HNO₃) complex, the extractant for the process. The extractant is prepared by vigorously mixing two equal volumes of TBP and concentrated nitric acid (70% HNO₃) for 10 s. During the mixing, the HNO₃ enters the upper TBP layer and complexes with TBP to form TBP-HNO₃ extractant. After separating the extractant from the underlying aqueous solution, an extractant is obtained that can strongly complex with REEs and extract them from CBRs.

The second step is extracting REEs from CBRs under supercritical fluid. The CO₂ used in this Example was purchased from Airgas. In this Example, either 2 g or 6 g of CBRs, along with 20 ml TBP-HNO₃, was loaded into a reactor (250 mL, Parr Instrument Co., IL). SCF was pressurized by a syringe pump (Teledyne Isco Inc., Lincoln, NE) and maintained at 150 bar. The temperature of the reactor was controlled at 50° C. The critical temperature and critical pressure for CO₂ are 31° C. and 74 bar, so the CO₂ in the experiment was supercritical. After 2 h of extraction, the reactor was cooled to room temperature and depressurized within 10 minutes. Reacted TBP-HNO₃, which contained REEs and impurities, was obtained by filtering out the remaining solid residues by 0.22 µm PVDF filters. The solid residues were rinsed with ethanol and DI water to remove any remaining solution from the extraction process and then prepared for further characterization.

The third step was conducting multistage stripping to selectively collect the REEs and separate them from the impurities using 1% nitric acid. Specifically, to collect REEs from the reacted TBP-HNO₃, 1% nitric acid was added to reacted TBP-HNO₃ in a 1:10 v/v ratio. This volume ratio was experimentally determined to be the best for concentrating REEs, as detailed below. After 10 s of vigorous mixing, the REEs and impurities dissociated from the TBP and dissolved into the diluted nitric acid. The diluted nitric acid containing REEs and impurities, collected by gravity separation, was called the stripped solution. The remaining reacted TBP-HNO₃ was mixed with fresh 1% nitric acid to conduct a new stripping stage. In total, a six-stage stripping process was conducted to recover essentially the REEs from the reacted TBP-HNO₃.

The fourth step is generating fresh TBP-HNO₃ from the stripped TBP-HNO₃. After a ten-stage stripping process to remove all the complexed metals, equal volumes of stripped TBP-HNO₃ and 70% nitric acid are vigorously mixed. After gravity separation, the obtained top layer is the new TBP-HNO₃. By re-using TBP-HNO₃ for extracting REEs from CBRs, the cost of the extraction process can be decreased organic waste generation can be minimized.

### Characterization of Solid Samples

The sizes, morphologies, and elemental distributions of CBRs were characterized by SEM-EDX (Thermofisher Quattro S Environmental Scanning Electron Microscope). All CBRs samples were measured by X-ray fluorescence (XRF) to obtain their major elemental composition, especially for silicon (Si). The CBR samples were digested by two methods, described below, to respectively obtain the total elemental composition and acid-extractable REEs element composition. In addition, the extracted solid residues were digested to obtain their total elemental composition, in order to calculate the extraction efficiency.

The digestions were performed in a microwave digestor. To quantify the total elemental composition, coal fly ash samples (34 ± 1 mg) were digested for 8 h at 90 -100° C. in a 1:1 mixture of 2 ml concentrated HF and 2 ml concentrated HNO₃. Then, after complete drying, the acid digested samples were re-digested for 8 h at 90 - 100° C. in a mixture of 1 ml concentrated HNO₃, 1 ml 30 - 32% H₂O₂, and 5 mL DI water. After re-digestion, the samples were diluted with additional 1% HNO₃ for further analysis. To quantify the acid-extractable REEs content, CFA samples (0.1-0.5 g) were digested in 10 ml concentrated HNO₃ at 85-90° C. for 4 h. The digested samples were again diluted with 1% HNO₃ for further analysis. The concentration of the REEs and impurities in the digested solutions were analyzed by inductively coupled plasma optical emission spectroscopy (ICP-OES, PerkinElmer Optima 7300 DV).

### Characterization of Liquid Samples

The concentration of HNO₃ in the TBP-HNO₃ complex was determined by acid-base titration with 0.1 M NaOH to an endpoint pH of 7.

To quantify the REE and impurity concentrations in each stripped solution collected from the ten-stage stripping process under SCF conditions, the solutions were diluted with 1% nitric acid and measured using ICP-OES.

To quantify the amount of REEs and impurities which had complexed with TBP, the reacted TBP-HNO₃ and stripped TBP-HNO₃ were separately digested. The digestion of liquid TBP-HNO₃ samples was performed according to known procedures. TBP-HNO₃ solutions were mixed with 1 mL DI water, 2 mL concentrated HNO₃, 0.4 ml 30 - 32% H₂O₂, and 0.4 ml concentrated HF. Then, eight digestion steps were performed within 1 h at 100° C. After the digestion, the samples were diluted by 1% HNO₃ and prepared for ICP-OES analysis.

### Extraction Selectivity Calculation

The partition coefficient (K_{d,m}) between the collected and the uncollected metal was calculated by the following equation:

$${K}_{d , m} = \frac{{m}_{c o l l e c t e d}}{{m}_{t o t a l} - {m}_{c o l l e c t e d}} ,$$

where m_{collected} is the mass of metal collected in the multistage stripping solution, and mₜₒₜₐₗ is the total mass of metal in the CBR.

To assess the REEs selectivity of the extraction and stripping process under the given experimental conditions, separation factors (SF_{Nd/m}) were determined by the amount of neodymium relative to each individual metal impurity, as follows:

$$S {F}_{N d / m} = \frac{{K}_{d , N d}}{{K}_{d , M}} ,$$

where K_{d,Nd} is the partition coefficient for neodymium, and K_{d,m} is the partition coefficient for metal impurity. Nd was selected as a reference REE because it was a relatively abundant REE in all the studied CBRs this work could be compared with other processes.

### REE Extraction From Coal, Bottom Ash, and Coal Fly Ash

Recent studies on REE fractions within coal-based resources (CBRs) have aroused interest in multiple processes for extracting them, including chemical leaching, solvent extraction, bioleaching, and liquid membrane processes. This Example uses supercritical CO₂, an environmentally friendly solvent, to assist the extractant (TBP-HNO₃) in selectively extracting REEs from CBRs. The tests used PRB coal, bottom ash (BA, heavier ash that settles in the bottom of the boiler), and coal fly ash (CFA-M, lighter ashes collected from the exhaust stream in a baghouse). All of these test samples came from a Missouri electric power company that burned PRB coal, and their major elemental compositions were determined by XRF (Table 9).

Table 9. Major elemental compositions and rare earth element concentrations in five different CBRs. Major elemental compositions were analyzed by XRF. After sequential HF—HNO₃ and HNO₃—H₂O₂ digestion, the total rare earth elements concentration in CBRs was quantified by ICP-OES. After HNO₃ digestion, the acid extractable REEs concentration in CBRs was quantified by ICP-OES and the acid-extractable percentage (%) was calculated.

| | | Major elemental compositions (%) | | | | | Rare earth elements | |
|---|---|---|---|---|---|---|---|---|
| Sample | Location | Si as SiO₂ | Al as Al₂O₃ | Fe as Fe₂O₃ | Ca as CaO | Mg as MgO | Total (ppm) | Acid-extractable (%) |
| Coal | Missouri | 4.4 | 1.9 | 1.0 | 2.9 | 0.6 | 20.3 | 65.1 |
| BA | Missouri | 41.5 | 20.4 | 5.5 | 13.7 | 7.3 | 300.5 | 16.1 |
| CFA-M | Missouri | 48.7 | 12.5 | 7.9 | 19.5 | 12.6 | 234.3 | 79.5 |
| CFA-K | Kentucky | 54.1 | 28.4 | 10.9 | 1.3 | 3.2 | 703.5 | 16.7 |
| CFA-T | Texas | 38.3 | 22.5 | 5.2 | 22.9 | 15.9 | 405.6 | 52.4 |

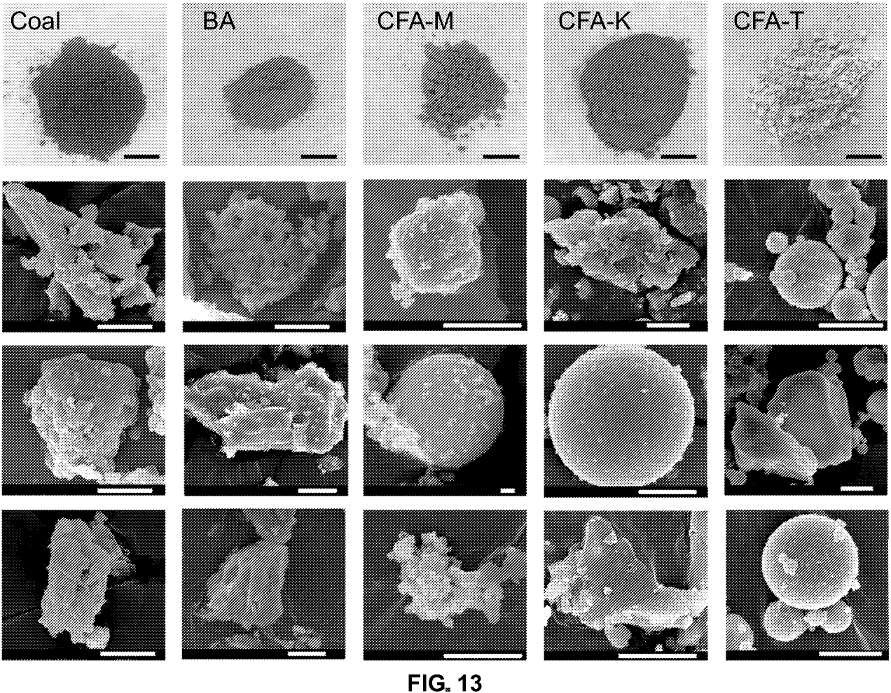

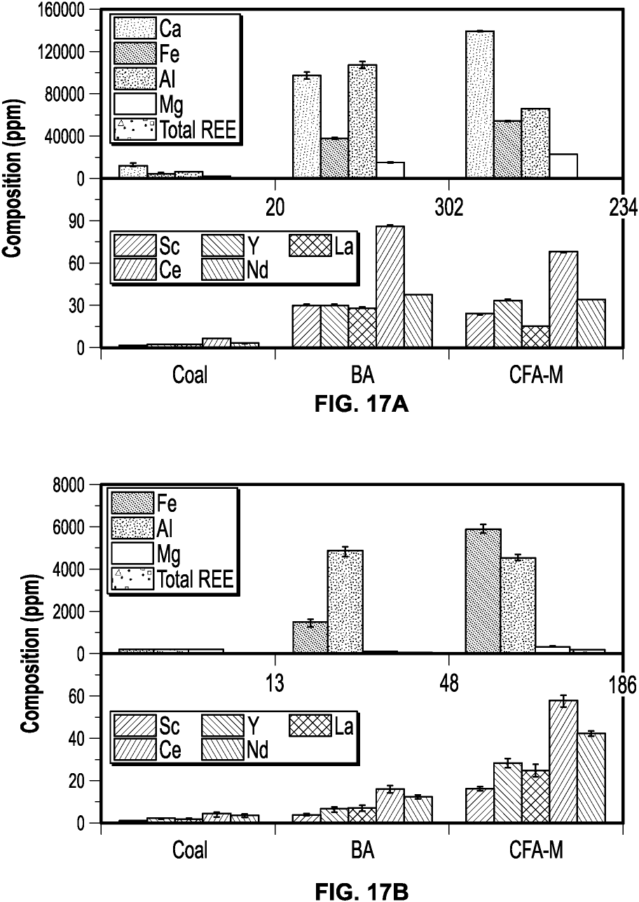

Before the experiments, by utilizing a scanning electron microscope (SEM), the particle morphologies of the coal, BA, and CFA-M were characterized. As FIG. 13 shows, the coal and BA samples are aggregates of irregular particles. Also, stacked layer and spherical particle morphologies appear in the CFA samples, which suggest the presence of minerals such as aluminosilicate and silica. After sequential digestion with hydrofluoric acid (HF)-nitric acid (HNO₃) and HNO₃-hydrogen peroxide (H₂O₂), the total concentrations of REEs in the CBRs were quantified (Table 9, FIG. 17). During coal combustion, REEs are reportedly retained and enriched in the fly ash. The present results similarly showed that BA and CFA-M contained around 200-300 ppm total REEs, higher than the REE contents in the PRB coal samples (60 ppm).

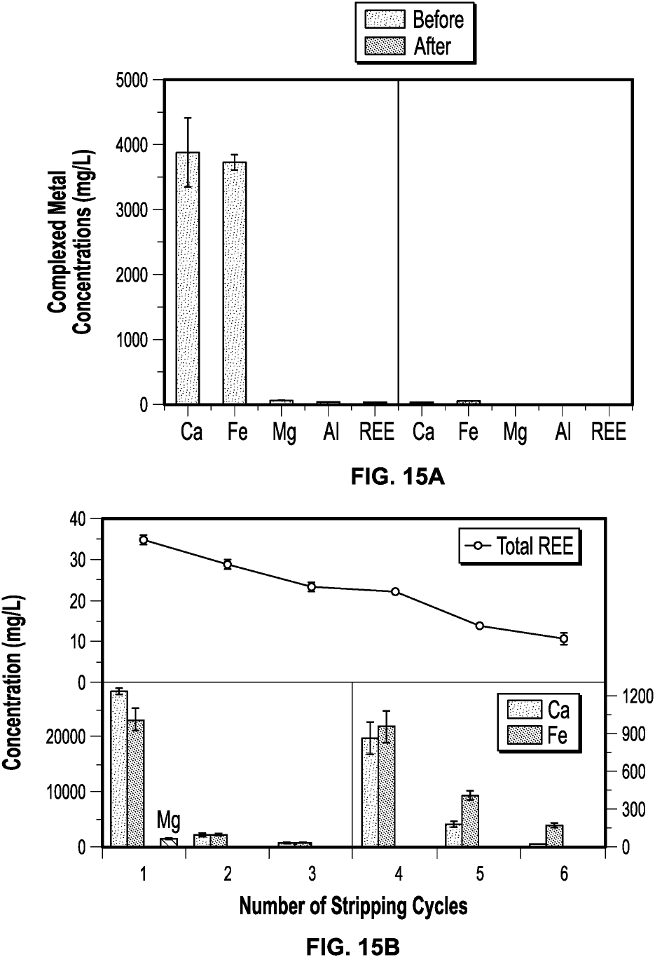

The REEs extraction experiments were conducted using a solid-to-liquid ratio of 2 g CBRs to 20 ml TBP-HNO₃, at 50° C. and under a supercritical CO₂ pressure of 150 bar. The composition of TBP-HNO₃ was quantified by acid-base titration to be TBP(HNO₃)_{1.67}, a value similar to those in previous studies using TBP-HNO₃ as extractant. After the extraction, the extracted REEs should be present as REE(NO₃)₃(TBP)₃ complexes in the reacted TBP-HNO₃. To test whether REEs were indeed extracted into TBP-HNO₃, the reacted CBRs were digested and their REEs were again quantified. Then, (Eq.3) defined above was applied to calculate the extraction efficiency for REEs. FIGS. 15A and 15B show the regeneration of the extractant TBP-HNO₃ for minimizing organic chemical usage. The multistage stripping results indicate that the regenerated TBP-HNO₃ is very little different from fresh TBP-HNO₃.

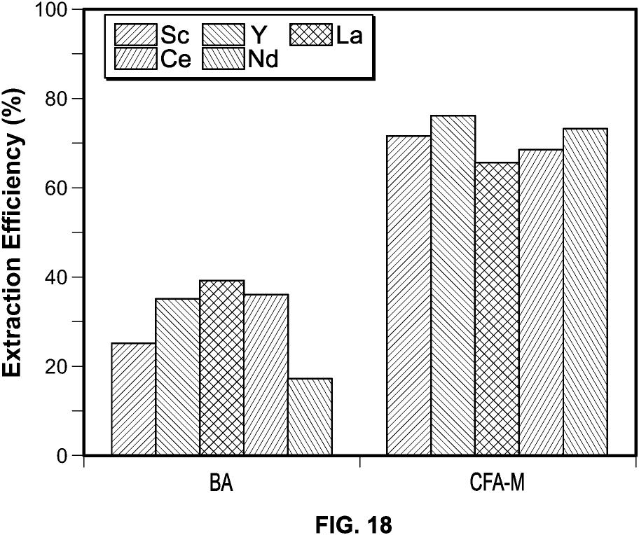

As shown in FIG. 18, the REEs extraction efficiency from BA (20-40%) is much smaller than that from CFA-M (70-80%). By digesting both with concentrated HNO₃, it was found that although BA and CFA-M have similar total REEs contents, the higher acid-extractable REEs portion in CFA (Table 9) allows a higher extraction efficiency. The higher acid-extractable REEs content in CFA-M is likely due to the higher calcium content, which enhances their solubility in nitric acid, because REEs coexisting with calcium will present as a more acid-soluble form. Moreover, acid-extractable REEs contents could be a critical criterion for evaluating the potential of CBRs as reliable REEs sources. Whereas conventional REEs recovery processes need large quantities of energy and chemicals to digest materials, the present process directly extracts REEs from solid phase CBRs, significantly reducing the energy consumption and chemical usage.

### Selective Extraction of REEs From Different Coal Fly Ashes

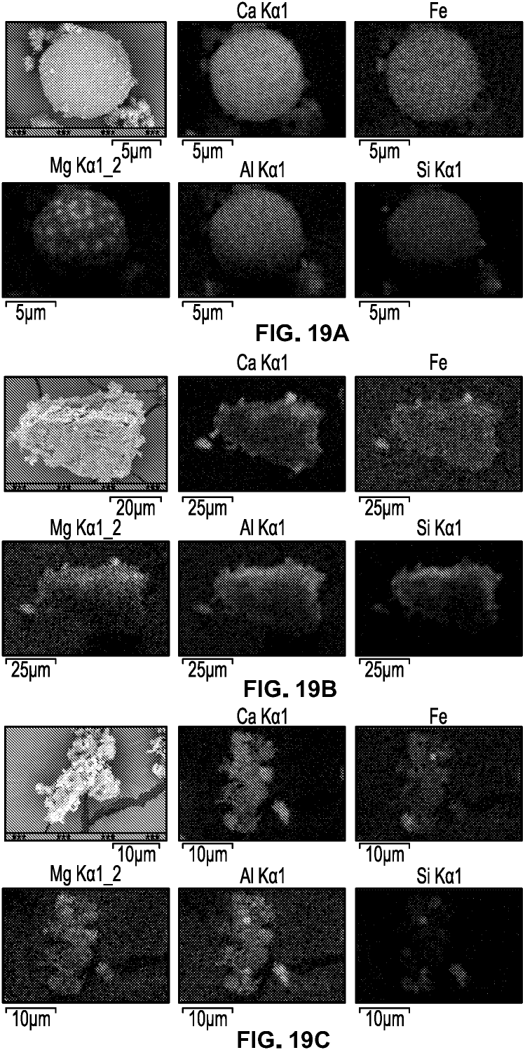

Recent characterizations have shown that the REEs contents and extractabilities of coal ashes are heavily dependent on the geological origin of the coal. Hence, to test whether the extraction method can accommodate different sources of CFAs, two additional CFA samples were selected with different origins, different REEs concentrations, and different major impurity compositions: CFA-K (from a Kentucky plant burning an Appalachian Basin coal) and CFA-T (from a Texas plant burning a Powder River Basin coal). SEM analysis also confirmed different morphologies of CFA particles, predominantly spherical particles ranging from 1 to 100 µm (FIG. 13), produced by particle melting and decomposition during the coal burning process. In addition, considerable amounts of irregular particles, which contained enriched Ca, Fe, and Al, were also found in the CFA samples (FIGS. 19A-19C). From the digestion results, CFA-M, CFA-K, and CFA-T contained 234.3±6.6 ppm, 703.5±0.25 ppm, and 405.6±5.8 ppm REEs. Although the absolute REE contents in fly ash were approximately two orders-of-magnitude less than those of conventional REE ore, the higher fraction of critical REEs (Nd, Eu, Tb, Dy, Y, and Er) in the fly ashes (32-34%) compared to that in conventional ore (< 10%) may represent an advantage. Nevertheless, the small amount of REEs, compared to the huge quantity of impurities, including Ca, Fe, Mg, Al, Na, clearly emphasizes the great challenge of selective REEs extraction.

In order to separate REEs and impurities and collect REEs from the organic complex, described herein is a multistage stripping process, shown in FIG. 12C. In each stripping stage, either reacted TBP-HNO₃ or stripped TBP-HNO₃ is mixed with 1% nitric acid using a 10:1 organic phase to aqueous phase volume ratio. In these stages, both REEs and impurities dissociate from TBP-HNO₃, enter the aqueous phase, and complex with water, as Eq. 8-10 show.

$$\begin{matrix}R E E {\left(N {O}_{3}\right)}_{3} {\left(T B P\right)}_{3} + 3 {H}^{+} + n {H}_{2} O \to R E E {\left({H}_{2} O\right)}_{n}^{3} + 3 H N {O}_{3} + \\ 3 T B P\end{matrix}$$

$$\begin{matrix}{M}_{1} {\left(N {O}_{3}\right)}_{3} {\left(T B P\right)}_{3} + 3 {H}^{+} + n {H}_{2} O \to {M}_{1} {\left({H}_{2} O\right)}_{n}^{3} + 3 H N {O}_{3} + \\ 3 T B P\end{matrix}$$

$$\begin{matrix}{M}_{2} {\left(N {O}_{3}\right)}_{2} {\left(T B P\right)}_{2} + 2 {H}^{+} + n {H}_{2} O \to {M}_{2} {\left({H}_{2} O\right)}_{n}^{2} + 2 H N {O}_{3} + \\ 2 T B P\end{matrix}$$

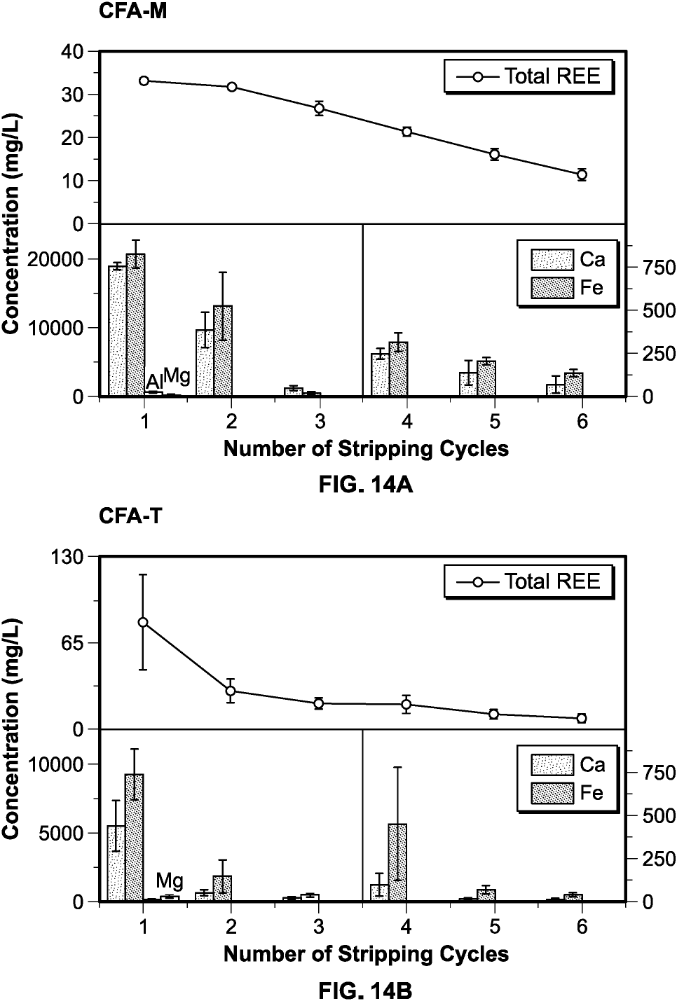

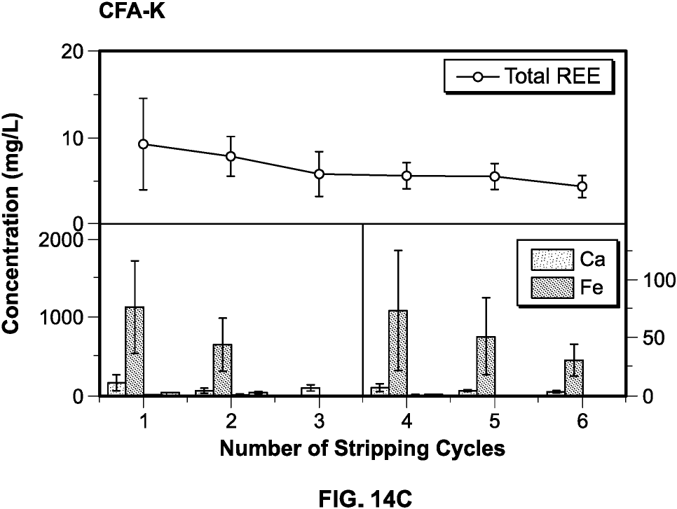

Here, n is moles of water molecule that complex with REEs/impurities, M₁ indicates the trivalent impurities (e.g., Fe³⁺, Al³⁺), and M₂ indicates the divalent impurities (e.g., Ca²⁺, Mg²⁺). The multistage stripping results are presented in FIGS. 14A-14C.

First, it is noted that even though Si, Al, and Mg account for approximately 75% of the CFAs, they are scarce in the stripping solution. In previous work, Si-containing minerals were hardly dissolved by HNO₃, and thus they remained as solid residue after the SCF extraction. Moreover, previous work also found that SCF could interact with TBP-HNO₃ to enhance the extractive selectivity for REEs over impurities (Ca, Al, and Mg), overturning the conventional view that SCF is inert during extraction. Therefore, the present SCF extraction showed unprecedented selective extraction of REEs over Si, Al, and Mg, no matter what type of CFA was used. Second, because Ca and Fe have a higher affinity for water than they do for REEs, Ca and Fe were mainly collected in the first and second stage stripping solution. REEs gradually entered the aqueous phase from the first stage stripping through the sixth stage stripping. In this way, some REEs content was sacrificed while stripping out large quantities of impurities: 64,000 mg/L of impurities for CFA-M, 2,200 mg/L for CFA-K, and 21,000 mg/L for CFA-T. These values are the sum of the impurity concentrations in the first and second stripping stage solutions. However, considerable amounts of REEs remain to be collected in the later stripping stages, with low impurity concentrations (ranging from 50 - 600 ppm). This selective stripping procedure allowed REEs purities of up to 16%, about 20-30 times higher than obtainable with conventional extraction. Lastly, not only was high REEs purity obtained, but by using a high organic phase to aqueous phase ratio, high concentrations of REEs from the three CFAs was also obtained: 11 - 33 mg/L (CFA-M), 4 - 9 mg/L (CFA-K), and 5 - 44 mg/L (CFA-T). Noticeably, the REEs concentrations obtained from CFA-M and CFA-T were much higher than the values reported for other techniques (0.3 - 6.4 mg/L), such as the liquid membrane process.

REEs in CFA have multiple forms, including REEs-bearing glass, REEs-bearing apatite, REEs oxide, and REEs phosphate. For the three CFA samples used in this Example, CFA-K had a chemical composition typical of Class-F CFAs that are enriched in SiO₂ (54%), Al₂O₃ (28%), and Fe₂O₃ (11%), while the CFA-M and CFA-T samples belong to Class-C CFAs, because they have abundant alkaline oxides (20-23% CaO and 1-5% MgO). Importantly, the form of a REE in a CFA determines its extractability. For example, compared to REEs-bearing glass, REEs oxides and REEs-bearing apatite have much higher solubility in acidic solution. Therefore, Class-F CFAs have been shown to have lower REEs extractability than Class-C CFAs, due to the low solubility of REEs-bearing glass. The results also demonstrated that, even though they contain the highest amount of REEs, the low acid-extractable REEs portion of CFA-K yielded a lower collected REEs concentration than other CFA samples. However, regardless of their different extractabilities or different impurity compositions, the process demonstrated great selectivity for REEs over impurities in different samples. This high yield was achieved by harnessing TBP’s extraction selectivity under SCF, and by capitalizing on the different water affinities of REEs and impurities.

In comparison, without any pretreatment, the purity of REEs extracted from leachate of CFAs using other techniques ranged from 0.5 - 0.8 %. The present REEs purity (up to 16%) is comparable to the reported biosorption process which utilized a pretreated REEs leachate, where most Al, Fe, and Si had been removed. The present REEs purity is not only statistically higher, but also comparable to the purity of some commercially available REEs ores. This commercial purity suggests that coal ashes can indeed become a promising REEs source, thereby countering the supply shortage.

### Minimization of Organic Extractant Demand and Organic Waste Generation

The world annually generates 600 - 800 million tons of coal ash. Less than 30% of this ash is beneficially reused: the majority is discarded and can cause severe environmental pollution and ecological damage if proper waste management is not applied. Therefore, it is worthwhile to explore environmentally sustainable methods to leverage existing coal ash deposits. Motivating recent attention to the valuable REEs in coal ashes, people have started to weigh the potential economic benefit and environmental impact of extracting REEs from coal ashes. The large amount of organic chemicals used from impurities during solvent extraction of REEs is a concern. By utilizing a “green” solvent, supercritical CO₂, instead of organic solvent, this disclosure has already significantly decreased the organic chemical demand (a reduction of 25 mL in organic solvent usage per gram of CBRs). But in order to achieve selective extraction, organic extractants are indispensable for all kinds of REEs extraction techniques, such as the TBP-HNO₃ used in SCF extraction, di-(2-ethylhexyl)phosphoric acid (DEHPA) commonly used in solvent extraction and liquid membrane processes, or the microorganism-synthesized surface functional groups in biosorption processes. So, in order to further minimize organic extractant demand and organic waste generation, the feasibility of reusing the TBP-HNO₃ in the present process has been investigated.

The extractant TBP-HNO₃ has two roles during SCF extraction. First, the HNO₃ dissolves REEs and impurities from the solid CBRs matrix. Second, the TBP and nitrate ions selectively form complexes with REEs and some impurities. It has also been found that during the multistage stripping process, the complexed REEs and impurities are dissociated from the TBP. Therefore, it is hypothesized that the extractability of TBP would not change if all the complexed metals (REEs and impurities) were enabled to dissociate from the TBP.

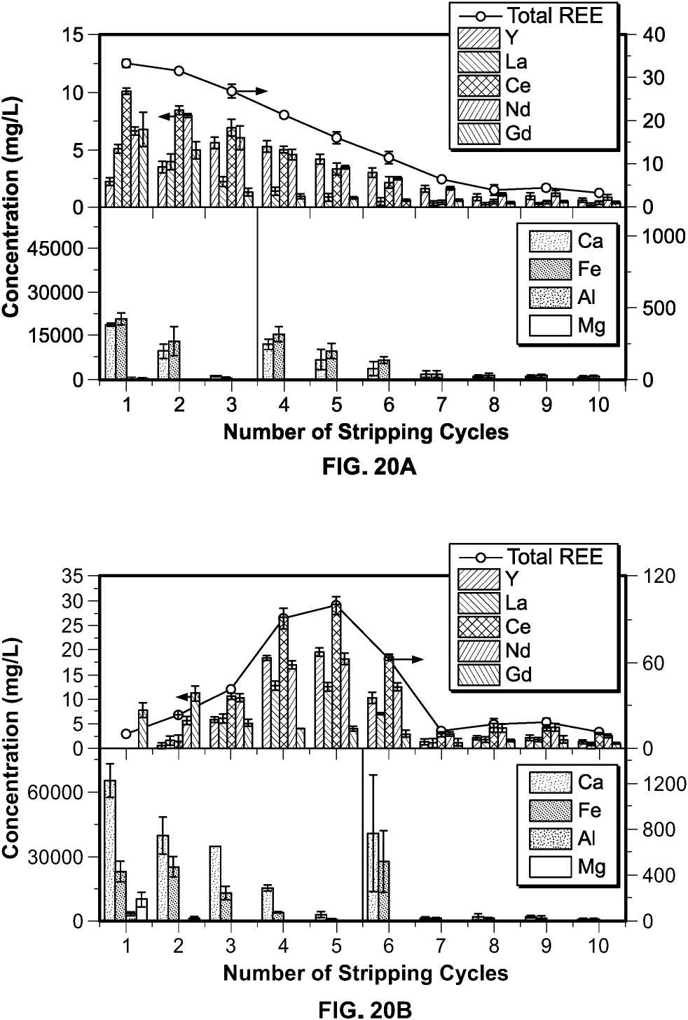

To do so, another four stripping stages were applied. As FIG. 20A shows, the concentrations of both REEs and impurities become quite small from the seventh stripping stage through tenth stripping stage. The stripped TBP-HNO₃ was digested from after the tenth stripping stage to quantify the remaining complexed metal concentrations, and compared with the complexed metal concentrations before multistage stripping (FIG. 15A). Clearly, all the complexed metal concentrations significantly decreased, indicating a 97% removal of complexed metals. Moreover, this removal also means that the TBP-HNO₃ regained an approximate 8000 mg/L complexing capacity for selectively extracting REEs from new CBRs. Because a large amount of HNO₃ was consumed during the reaction with CBRs, the new TBP-HNO₃ was regenerated using the stripped TBP-HNO₃ and adding 70% nitric acid, as FIG. 12D shows. Then, the performance of the regenerated TBP-HNO₃ in extracting REEs from CFA-M was tested. After a 2 h extraction reaction under 50° C. and 150 bar supercritical CO₂, the multistage stripping process was applied.

As shown in FIG. 15B, the total REEs concentrations in the stripping solutions from the first stripping stage through the sixth stripping stage are still within 10 -35 mg/L, with little difference from the stripping results using freshly made TBP-HNO₃. As expected, the distribution of impurity concentrations in all six stripping stage solutions for regenerated TBP-HNO₃ follow a similar trend to the fresh TBP-HNO₃ results, because the stripping is controlled by the water affinity difference between REEs and impurities. Thus, for regenerating TBP-HNO₃, a 10 stage stripping process can remove nearly all the REEs and impurities. As a result, the TBP-HNO₃ can be regenerated to minimize both organic extractant demand and organic waste generation.

The annual reported total U.S. tonnage of rare earths (reported as rare earth oxide (REO)) in unused fly ash is 4000 t for the Northern and Central Appalachian Basin, 1280 t for the Illinois Basin, and 3630 t for the Powder River Basin, for total of approximately 8910 t. Considering the cost of current separation technologies, those REEs correspond to a $4.3 billion total annual value. According to a life cycle analysis of SCF extraction of REEs from coal ashes, the cost of chemical reagent is estimated as over 50% of the total cost. With these numbers in mind, the new TBP-HNO₃ regeneration process is a clearly promising step toward both decreasing the environmental impact of the extraction process and increasing the economic value of REEs extracted from coal ashes.

### Solid-to-liquid Ratios Tune the Separation of REEs and Impurities

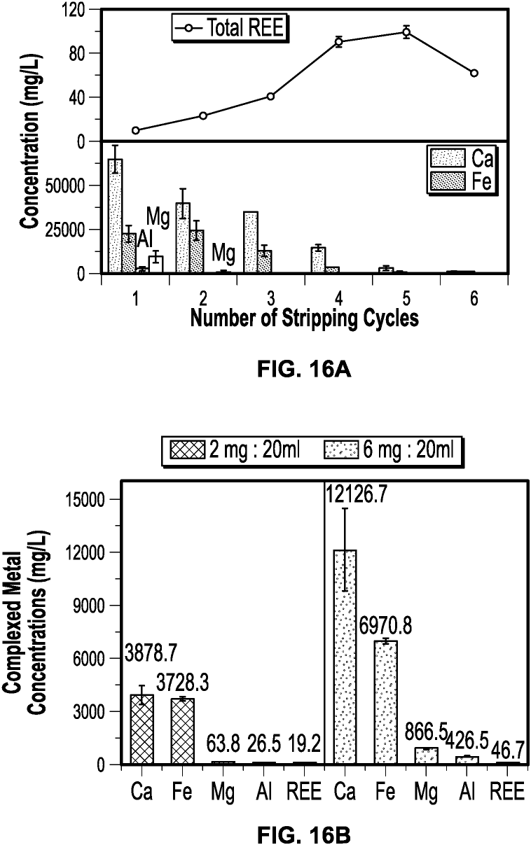

When the 2 g CFA: 20 mL TBP-HNO₃ is applied as the solid-to-liquid ratio, some portion of REEs are inevitably removed in the first and second stripping stages. Due to their different water affinities, the majority of impurities enter the stripping solution in the first and second stages, while a considerable amount of high purity and high concentration REEs can be collected from the third stripping stage through the sixth stripping stage (FIG. 16A). Surprisingly, it was found that by increasing the solid-to-liquid ratios (6 g CFA-M: 20 mL TBP-HNO₃) in the SCF extraction, the impurities and REEs could be successfully prompted to be collected in different stripping stage solutions.

As shown in FIG. 16B, major impurities, including Ca, Fe, Al, and Mg, were still mainly collected in the first two stages. Compared to the more than 65,000 ppm of Ca and 23,000 ppm of Fe in the first stripping solution stage, Ca and Fe concentrations in fourth through sixth stages rapidly decreased, becoming lower than 15,000 ppm and 4,000 ppm, respectively. Interestingly, it was found that REEs could barely be collected in the first two stages. Instead, most REEs dissociated with TBP and entered the stripping solution from the fourth through sixth stages. For the first time, it was found that the distribution of REEs and other metal impurities in the multistage stripping solutions could be tuned to achieve better separation. Moreover, due to the larger amount of CFA used and smaller loss of REEs in the early stage stripping, an unprecedented concentration of extracted REEs from CBRs was obtained: 100 mg/ L in the fifth stage stripping (FIG. 16B).

To investigate how the solid-to-liquid ratio in the extraction process influences the stripping results, the reacted TBP-HNO₃ obtained after two different extraction experiments was digested to quantify the complexed metal concentrations. As FIG. 16B shows, the higher solid-to-liquid ratio increased the complexed Ca, Fe, Al, Mg, and REEs concentrations.

Notably, a three-fold increase in the CFA-M feed did not simply treble the concentrations of impurities and metals, it also increased the amounts of extracted impurities and raised the impurities/REEs concentration ratios. As Eq. 8-10 show, in a single stripping stage, the REEs and impurities could be considered as undergoing a competitive complexation process. Both REEs and impurities compete for water molecules to enable them to dissociate from TBP molecules, especially when the available free water molecules are limited (as in the 10:1 phase ratio used in the multistage stripping process). Compared to REEs, impurities with higher water affinities complex faster with water molecules and form thermodynamically more stable complexes. Therefore, it was found that when a higher solid-to-liquid ratio was used in the extraction, a large amount of impurities rapidly complexed with all the available water molecules, so that no water molecules remained for complexing REEs. Thus, REEs could not dissociate from TBP in the early stripping stages. Only when the impurities in the TBP had been stripped out could REEs find enough water molecules to complex and be collected in later stripping stages.

### Comparisons to Other Work

Due to the chemical complexity of the CBRs and the presence of impurities with much higher concentrations, this Example and other works have explored feasible techniques to selectively extract REEs. Here, the benefits and advantages of the present disclosure are compared to other published work based on selectivity for REEs over impurities. As Eq. 6 showed earlier, the selectivity for REEs over impurities was calculated by the separation factor for neodymium (Nd) relative to each major impurity. Nd was selected as a representative REE due to its criticality and high abundance in CBRs, and its ease of comparison across other studies.

As Table 10 shows, a larger separation factor indicates a higher selectivity for REEs over impurities. A short dash (-) means that all of that type of impurity has been removed. For the major impurities in CBRs, compared to other studies, the present methods exhibited superior selectivity for REEs over K, Na, Al, Ba, Sr, and Si. Monovalent ions (K⁺ and Na⁺) and divalent ions (Ba²⁺ and Sr²⁺) were removed because of TBP’s non-preferential complexation. Si was not collected because it cannot be dissolved by nitric acid. Removal of Al³⁺ is attributed to the SCF’s impact on the reactivity of TBP with Al³⁺.

The successful removal of Al and Si is especially important, because the majority of REEs in CBRs coexist in aluminosilicate glasses. Moreover, studies have shown that Al strongly interferes with the selective extraction of REEs. Ca and Fe have their higher water affinities than REEs, and this Example capitalized on this difference to remove most of these elements, but their separation factor is lower than in other studies. However, the present process can be combined with other techniques to further remove such impurities. While other techniques extract REEs from an aqueous leachate solution, the present process directly extracts REEs from solid CBRs matrix and then generates a REEs-containing aqueous solution, thereby significantly reducing the energy consumption, chemical usage, and number of operating procedures. Therefore, the aqueous stripping solution generated by the process is a rich source of REEs for other techniques. By combining the benefits of different techniques, all the impurities could potentially be removed to produce high purity REE products.

Table 10. Comparison of the separation factor, SF, and collected REEs concentrations for this Example (first four rows) and other studies. The separation factor was calculated using Eq. 6. A larger separation factor indicates a better selectivity for REEs over impurities. A short dash indicates that this impurity was not detected in the product. NA indicates that the data are not unavailable.

| | Log₁₀SF | | | | | | | | | | REEs concentrations (mg/L) |
|---|---|---|---|---|---|---|---|---|---|---|---|
| | Ca | Fe | K | Na | Mg | Al | Ba | Mn | Sr | Si | |
| CFA-M 2 mg:20 ml | 1.89 | 1.52 | - | - | - | - | - | 2.42 | - | - | 18.95 |
| CFA-M 6 mg:20 ml | 0.82 | 0.89 | - | - | 2.82 | 4.49 | - | 1.23 | 3.49 | - | 73.34 |
| CFA-K | 1.34 | 0.93 | - | - | 1.83 | - | - | 0.02 | - | - | 5.27 |
| CFA-T | 2.41 | 1.18 | - | - | 3.63 | - | - | 1.05 | - | - | 10.13 |
| KSE^{∗} | 1.39 | 2.92 | 3.76 | 4.45 | 3.37 | 0.46 | 2.87 | 2.08 | 3.29 | 3.71 | 5.59 |
| SLM^{∗} | 1.25 | 1.08 | 1.66 | 1.90 | 1.90 | 1.60 | 1.91 | 1.58 | 1.88 | 1.68 | 0.30 |
| LFM^{∗} | 0.38 | 2.48 | 2.00 | 2.06 | 1.43 | 1.11 | 1.22 | 0.40 | 1.16 | 2.45 | 4.63 |
| BSE^{∗} | 2.75 | - | 2.63 | NA | 2.66 | 1.27 | - | 2.50 | 2.92 | 2.45 | 4.49 |
| BS^{∗} | 2.22 | - | 2.43 | NA | 2.34 | 1.53 | 2.40 | 2.10 | 2.37 | 2.15 | 4.33 |

^{∗}Results for KSE, SLM, LFM, BSE, and BS are obtained from references (1) Smith et al., Environ. Sci. Technol., 2019, and (2) Park et al., Sep. Purif. Technol., 2020, 241, 116726.

### Conclusions.

In this Example, a new process is demonstrated for recovering valuable REEs from previously underutilized coal-based resources (CBRs), especially coal ashes. Instead of using a conventional organic solvent, a “greener” solvent was used: carbon dioxide in a supercritical fluid (SCF) state. Using this SCF, REEs were selectively extracted from five different solid CBR samples.

Two mechanisms enabled extraction of a high purity of REEs (up to 16%). First, by utilizing SCF, the extractant TBP-HNO₃ showed lower complexing with impurities, including Si, Al, Mg, and Ca. Then, harnessing the water affinity difference between the remaining impurities and REEs, REEs and impurities were separately collected in different stages during a multistage stripping process. Specifically, when a higher CBR-to-extractant solid-to-liquid ratio was used, there was better separation between the REEs and impurities. After that, the reusability of the extractant in the process was explored. It was found that the performance of the regenerated TBP-HNO₃ differed very little from that of fresh TBP-HNO₃. Accordingly, the present process can minimize the consumption of organic chemicals and generation of organic waste. This environmentally friendly process produces an aqueous solution with a high concentration of high purity REEs. It expands the sources of REEs from mineral ores and post-consumer products to previously neglected CBRs, previously regarded as a waste and environmental threat.

This written description uses examples to illustrate the present disclosure, including the best mode, and also to enable any person skilled in the art to practice the disclosure, including making and using any compositions or systems and performing any incorporated methods. The patentable scope of the disclosure is defined by the claims, and may include other examples that occur to those skilled in the art. Such other examples are intended to be within the scope of the claims if they have elements that do not differ from the literal language of the claims, or if they include equivalent elements with insubstantial differences from the literal language of the claims.

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed disclosure. The term “consisting essentially of” occupies a middle ground between “comprising” and “consisting of”.

Where a disclosure or a portion thereof is defined with an open-ended term such as “comprising,” it should be readily understood that (unless otherwise stated) the description should be interpreted to also describe such a disclosure using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the disclosure are intended to be nonrestrictive regarding the number of instances (i.e., occurrences) of the element or component. Therefore “a” or “an” should be read to include one or at least one, and the singular word form of the element or component also includes the plural unless the number is obviously meant to be singular.

What is claimed is:

1. A process for obtaining at least one rare earth element from a coal-based resource, the process comprising:
forming a mixture comprising
an extractant complex; and
a coal-based resource comprising at least one rare earth element;
extracting the at least one rare earth element from the mixture in the presence of a supercritical fluid; and
recovering the at least one rare earth element in at least one stripping stage.

2. The process of claim 1, wherein the coal-based resource is selected from the group consisting of coal, coal ash, acid mine drainage, and combinations thereof.

3. The process of claim 1, wherein the coal-based resource comprises seventeen rare earth elements.

4. The process of claim 1, wherein the extractant complex is formed according to a process comprising mixing an extractant and an acid.

5. The process of claim 1, wherein the extractant complex is selected from the group consisting of TBP-HNO₃, TBP-HNO₃, TTA-HNO₃, TRPO-HNO₃, β-diketone, and combinations thereof.

6. The process of claim 1, wherein the supercritical fluid is selected from the group consisting of supercritical CO₂, supercritical N₂, supercritical air, ethane, propane, ethylene, propylene, nitrous oxide, and combinations thereof.

7. The process of claim 1, wherein the process step of recovering the at least one rare earth element in at least one stripping stage comprises selectively recovering the at least one rare earth element.

8. The process of claim 1, wherein the process step of recovering the at least one rare earth element in at least one stripping stage comprises recovering the at least one rare earth element in at least six stripping stages.

9. The process of claim 1, wherein the process step of recovering the at least one rare earth element in at least one stripping stage comprises recovering the at least one rare earth element in at least ten stripping stages.

10. The process of claim 1, wherein the process further comprises regenerating the extractant.

11. The process of claim 10, wherein the process step of regenerating the extractant comprises adding an acid to the extractant.

12. The process of claim 10, wherein the process step of regenerating the extractant comprises
performing a gravity separation of a mixture of an acid and the extractant; and
recovering a regenerated extractant from a top layer of the gravity separation.

13. The process of claim 1, wherein the extractant complex is a regenerated extractant complex.

14. The process of claim 1, wherein the recovered at least one rare earth element has a purity of from about 1% to about 16%.

15. The process of claim 1, wherein the recovered at least one rare earth element has a purity of from about 1% to about 10%.

16. The process of claim 1, wherein the mixture comprises a solid-to-liquid ratio in a range of from about 1 mg coal-based resource : 20 ml extractant complex to about 10 mg coal-based resource : 20 ml extractant complex.

17. The process of claim 1, wherein the mixture comprises a solid-to-liquid ratio in a range of from about 2 mg coal-based resource : 20 ml extractant complex to about 6 mg coal-based resource : 20 ml extractant complex.

18. A rare earth element obtained according to the process of claim 1.

19. The rare earth element of claim 18, wherein the rare earth element is selected from the group consisting of scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), and combinations thereof.

20. The rare earth element of claim 18, wherein the rare earth element has a purity of from about 1% to about 16%.
